(19) United States
(12) Patent Application Publication
(10) Pub. No.: US 2012/0046807 A1
(43) Pub. Date: Feb. 23, 2012

(54) System and Method for Preventing Theft of Vehicle Diagnostic Equipment

(75) Inventors: Timothy G. Ruther, Carpentersville, IL (US); Carl Krzystofczyk, Mount Prospect, IL (US)

(73) Assignee: SNAP-ON INCORPORATED, Kenosha, WI (US)

(21) Appl. No.: 12/859,011

(22) Filed: Aug. 18, 2010

(51) Int. Cl. G06F 19/00; B60R 25/10

(52) U.S. Cl. 701/2; 340/426.18

(57) ABSTRACT

Disclosed are systems and methods for detecting and responding to a potential theft of a display device and/or vehicle diagnostic device in a modular vehicle diagnostic system. Display devices and/or vehicle diagnostic devices may monitor a status of a wireless communications link between them and, responsive to detecting a break in the link, execute one or more anti-theft responses. Furthermore, a display device may maintain a whitelist and/or be in communications with an authentication and anti-theft server, and may determine whether to execute an anti-theft response and/or accept a connection request from a new vehicle diagnostic device based on the whitelist contents and/or based on a response from the server. Anti-theft responses may include sounding an alarm, ceasing function and/or locking up, reporting a potential theft, transmitting a location of the potentially stolen device, or other responses.

### BACKGROUND

Vehicles, such as automobiles, light-duty trucks, and heavy-duty trucks, play an important role in the lives of many people. To keep vehicles operational, some of those people rely on vehicle technicians to diagnose and repair their vehicle.

Vehicle repair technicians use a variety of tools in order to diagnose and/or repair vehicles. Those tools may include common hand tools, such as wrenches, hammers, pliers, screwdrivers and socket sets, or more vehicle-specific tools, such as cylinder hones, piston ring compressors, and vehicle brake tools.

Modern vehicles have evolved into very complex machines with thousands of various parts that perform a vast array of operations that permit the vehicle to be operated by the user. Additionally, more and more vehicle operations that previously were controlled by mechanical interactions are instead being controlled by electronic control circuits and logic. As with any such complex machine, malfunctions may occur in one or more parts of the vehicle from time to time, including the electronic control circuits.

As a result, repair technicians must now rely on sophisticated, and expensive, electronic diagnostic equipment to diagnose and repair vehicular malfunctions. Diagnostic devices such as data acquisition devices (DAQs), vehicle scanner devices (vehicle scanners), and display devices have been developed to aid in diagnosing the sophisticated electronic equipment. DAQs incorporate various measurement functions such as voltage and current measurement probes to aid a repair technician in diagnosing a vehicle under test.

Vehicle scanners may be used to access electronic equipment within the vehicle under test and retrieve status and error information from that electronic equipment. Modern vehicles include an on-board diagnostic port (OBD port) or a diagnostic link connector (DLC). An OBD port or DLC generally comprises a plug-in type connector that is coupled to an on-board computer within the vehicle. The on-board computer is then coupled to various sensors at various places within the vehicle. The sensors can report current operating characteristics of vehicle elements and/or sense the existence of a malfunction in the various vehicle elements. By plugging in an appropriate vehicle scanner into the OBD or DLC, status or error codes can be retrieved from the OBD or DLC. These error codes may provide information as to the source of a malfunction in the electronic control circuits in the vehicle.

In order to further process data received from the DLC or OBD port, the vehicle scanner may transmit the vehicle diagnostic data to another, more robust processing device, such as the display device. The display device may further contain a database of information about the particular vehicle under test from which the data is retrieved, and may correlate the error codes retrieved to particular malfunctions and perhaps display further diagnostic steps that may be taken to diagnose the problem. Further diagnostic steps may include the retrieval of additional diagnostic information from the OBD or DLC port via the vehicle scanner device, the measurement of vehicle attributes using the DAQ, or some other action.

By providing the repair technician with detailed information for quickly diagnosing and repairing vehicles, vehicle repair times can be decreased, vehicle turn-over is increased, and as a result, repair technicians may reap increased profits from a same amount of garage space.

### OVERVIEW

Disclosed herein are methods and systems for detecting and preventing theft of diagnostic equipment such as vehicle scanners and DAQs. By providing for a modular separation of vehicle scanner, DAQ, and display device, and providing for wireless data connections between them, costs of the individual devices can be reduced while improving ease of use and eliminating garage clutter. In order to compensate for the increased portability and cost of such devices, and a commensurate increase in the ease of theft of such devices, embodiments are disclosed that prevent theft by detecting and deterring the removal of diagnostic devices from their operating area, and furthermore, that provide a means to track stolen diagnostic devices and either report their location or prevent their further use.

In accordance with a first embodiment of a diagnostic device, a method of detecting and preventing theft of diagnostic equipment includes the diagnostic device monitoring a status of a wireless communications link with a display device via a wireless communications interface, and responsive to detecting a break in wireless connectivity with the display device, executing an anti-theft response. The anti-theft response may comprise one or more different responses. For example, the response may include sounding an audible alarm at the diagnostic device. Additionally or alternatively, the response may include locking the diagnostic device and preventing further use of the diagnostic device. Other anti-theft responses could also be implemented.

In one embodiment, the anti-theft response may continue until the processor in the diagnostic device detects that wireless connectivity with the display device has been restored. In a further embodiment, the anti-theft response may be executed by the diagnostic device only after a predetermined period of time after detecting the initial break in wireless connectivity. The predetermined period of time may be, for example, between 0 and 600 seconds. Additionally, after detecting the break in wireless connectivity but prior to expiration of the predetermined period of time, the diagnostic device may provide a visual indication of the break in wireless connectivity, allowing a repair technician time to restore wireless connectivity prior to executing the anti-theft response.

In accordance with a second embodiment of a diagnostic device, a method of detecting and preventing theft of diagnostic equipment includes the diagnostic device detecting an available display device within wireless communication range of the diagnostic device, transmitting a connection request to the display device, receiving a challenge request from the display device, responsively prompting a user to enter a password via an input interface provided at the diagnostic device, and transmitting the entered password to the display device. The input interface may include input elements such as one or more of buttons, switches, and rotary dials. The password transmitted to the display device may include a combination of two or more activations of the input elements. In the event an incorrect password is entered and transmitted to the display device, the diagnostic device may receive an indication of the failure and may prompt the user to reenter the password. After transmitting a predetermined number of incorrect passwords, the diagnostic device may receive an instruction to lockup and prevent further functioning of the vehicle diagnostic device, and responsively lock up and prevent further functioning until unlocked or perhaps for a predetermined amount of time.

In accordance with a third embodiment, a method of detecting and preventing theft of diagnostic equipment includes a diagnostic device such as a display device wirelessly connecting and communicating with a diagnostic device, identifying and storing an identifier associated with the diagnostic device with which the display device is in wireless communications with, and responsive to detecting a break in wireless connectivity with the diagnostic device, executing an anti-theft response. The anti-theft response may comprise one or more different responses. For example, the response may include the display device transmitting the identifier associated with the diagnostic device to a remote authentication and tracking server via the network communications interface and reporting the at least one of the diagnostic devices as potentially stolen. Additionally or alternatively, the response may include sounding an audible alarm. The audible alarm increases in volume over time the longer the break in wireless connectivity exists. Other anti-theft responses could be implemented as well.

In one embodiment, the anti-theft response may be executed only after a lapse of a predetermined period of time after detecting the initial break in wireless connectivity. The predetermined period of time may be more than 0 seconds and less than 600 seconds. In addition, after detecting the break in wireless connectivity but prior to expiration of the predetermined period of time, the display device may provide a visual indication of the break in wireless connectivity, which may allow the condition to be remedied prior to the display device executing an anti-theft response. The visual indication may comprise, for example, a lighted indictor at an outer surface of the first diagnostic device.

In accordance with a fourth embodiment, a method of detecting and preventing theft of diagnostic equipment includes a display device wirelessly receiving a new connection request and an identifier from a new diagnostic device, and the display device determining whether the new diagnostic device is potentially stolen. In response to determining that the new diagnostic device is not potentially stolen, the display device accepts the new connection request from the new diagnostic device. Alternatively, and in response to determining that the new diagnostic device is potentially stolen, the display device executes an anti-theft response.

The display device may determine whether or not the diagnostic device is stolen in one or more ways. For example, the display device may transmit the identifier associated with the new diagnostic device to a remote authentication and tracking server via a network communication interface. In response to the transmission, the display device may then receive a response from the remote authentication and tracking server indicating whether or not the new diagnostic device is potentially stolen. If a response indicating that the new diagnostic device is potentially stolen, an anti-theft response may be taken. If the response indicates that the new diagnostic device is not potentially stolen, a connection may be created between the display device and diagnostic device.

Alternatively, the display device may access a locally stored whitelist and compare the indicator provided by the new diagnostic device with one or more whitelisted indicators stored in the whitelist. Responsive to finding a match, the display device may determine that the new diagnostic device is not potentially stolen. If no match is found, the display device may determine that the new diagnostic device is potentially stolen. Of course, a blacklist of indicators could alternatively be used, such that a match would indicate that the new diagnostic device is potentially stolen, and no match would indicate the opposite.

In another embodiment, the display device may determine whether or not the diagnostic device is stolen by transmitting a challenge request to the new diagnostic device. In response to the transmission, the display device receives a password comprising two or more input interface activations from the new diagnostic device. The display device may then compare the received password to a stored password. If a match is found, the display device may determine that the new diagnostic device is not potentially stolen. If no match is found, the display device may determine that the new diagnostic device is potentially stolen.

The anti-theft response taken by the display device may comprise one or more different responses to a determination that the new diagnostic device is potentially stolen. For example, the anti-theft response may include the display device providing an indication of the new diagnostic device's potentially stolen status via a visual or audio indicator. Alternatively or additionally, the display device may transmit an instruction to the new diagnostic device to lock up and cease further functioning. The anti-theft response could further comprise the display device transmitting a location of the new diagnostic device to the remote authentication and tracking server and an indication of its potentially stolen status. The transmitted location may include one or more of a GPS provided location and a triangulated location of the display device or of the new diagnostic device.

In accordance with a fifth embodiment, a method of detecting and preventing theft of diagnostic equipment includes a diagnostic device, in response to detecting a trigger, transmitting an identifier associated with the diagnostic device to a remote authentication and tracking server via a network communications interface and requesting a status of the diagnostic device. In response to receiving the request, the remote authentication and tracking server may respond with a status of the diagnostic device, including for example, clear (perhaps indicating no reported thefts) or potentially stolen (perhaps indicating a reported theft). In response to receiving a clear indication, the diagnostic device may provide access to diagnostic device functions and/or accept new connection requests from other diagnostic devices. In response to receiving a potentially stolen indication, the diagnostic device executes an anti-theft response. In one embodiment, the diagnostic device may be a display device, and the other diagnostic devices may be vehicle scanners or DAQs.

The trigger may be one selected from the group consisting of receiving operating power, detecting an available connection with a remote authentication and tracking server, and an expiration of a predetermined period of time. For example, upon receiving operating power, the diagnostic device may startup in a “locked” mode, and only unlock and provide its intended functionality after successfully receiving a clear response from the remote authentication and tracking server. The diagnostic device may, alternatively, provide functionality upon power up, but begin attempting to contact the remote authentication and tracking server and, upon successful contact, conduct the theft status check. Additionally, the diagnostic device may, at predetermined intervals, conduct another check via the remote authentication and tracking server.

The anti-theft response taken by the diagnostic device may comprise one or more different responses. For example, the response may comprise the diagnostic device transmitting a location of the diagnostic device to the remote authentication and tracking server and an indication of its potentially stolen status. The operator of the server may then use this information to contact the proper authorities or perhaps the registered owner of the diagnostic device. The location information may be provided by a GPS receiver, or may be generated by a triangulation operation executed by the diagnostic device. Other methods of determining location could also be used.

Furthermore, the anti-theft response taken by the diagnostic device may include the diagnostic device locking up and ceasing further functioning. Additionally or alternatively, the diagnostic device may provide an indication of its potentially stolen status via a visual or audio indicator. Other anti-theft responses could also be implemented.

The diagnostic device may also take action if it is unable to reach the authentication and tracking server over a pre-determined period of time. For example, the diagnostic device may provide an indication that connectivity must be provided to the remote authentication and tracking server within a second pre-determined amount of time, after which second pre-determined amount of time, the diagnostic device will execute an anti-theft response, including for example, locking up and ceasing to function. If the diagnostic device locks up, the diagnostic device may cease to function until an unlock key is provided. The unlock key may be, for example, a particularly formatted packet provided to the diagnostic device via a network communications interface (and perhaps transmitted by the authentication and tracking server by a 3^{rd} party after the 3^{rd} party is contacted by the diagnostic device user and provides evidence that it is not, in fact, stolen). The unlock key may alternatively comprise a particular combination of input element operations operated by a user on an external input interface of the diagnostic device. Other methods of unlocking the display device could also be used. In a preferred embodiment, the diagnostic device is a display device. In other embodiments, the diagnostic device may be a DAQ or a vehicle scanner. Other devices could also be used.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments of the invention are described herein with reference to the drawings, in which:

FIG. 1 is a block diagram of a system in which a display device and diagnostic devices in accordance with an example embodiment may operate;

FIG. 2 is a block diagram of a first example diagnostic device (a display device);

FIG. 3 illustrates a view of an example display device;

FIG. 4 is a block diagram of a second example diagnostic device (a vehicle scanner);

FIGS. 5-7 illustrate three views of the example vehicle scanner of FIG. 4;

FIG. 8 is a block diagram of a third example diagnostic device (a data acquisition device (DAQ));

FIG. 9 illustrates a view of the example DAQ of FIG. 8;

FIG. 10 illustrates a movement of a diagnostic device from within communication range of another diagnostic device to outside of the range of the another diagnostic device;

FIG. 11 illustrates a process flow that a DAQ and/or vehicle scanner may execute in accordance with the embodiment of FIG. 10.

FIG. 12 illustrates a process flow that a display device may execute in accordance with the embodiment of FIG. 10.

FIG. 13 illustrates a movement of a diagnostic device from outside of the range of another diagnostic device to within range of the another diagnostic device;

FIG. 14 illustrates a process flow that a DAQ and/or vehicle scanner may execute in accordance with the embodiment of FIG. 13.

FIG. 15 illustrates a process flow that a display device may execute in accordance with the embodiment of FIG. 13.

FIG. 16 is a process flow that a diagnostic device may execute responsive to detecting a trigger event.

### DETAILED DESCRIPTION

### I. Example Architecture

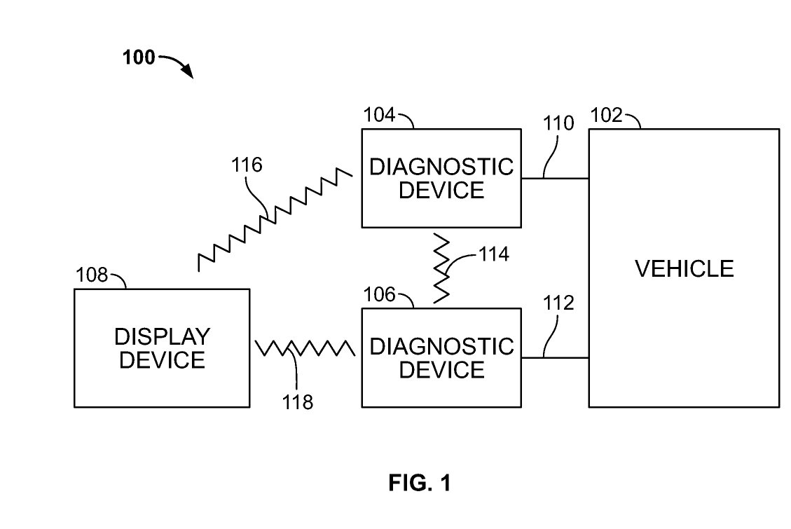

FIG. 1 is a block diagram of a system 100 in accordance with an example embodiment. System 100 comprises a vehicle 102 under test, a first diagnostic device 104, a second diagnostic device 106, and a third diagnostic device 108 (illustrated as a display device).

The block diagram of FIG. 1 and other block diagrams and flow charts accompanying this description are provided merely as examples and are not intended to be limiting. Many of the elements illustrated in the figures and/or described herein are functional elements that may be implemented as discrete or distributed components or in conjunction with other components, and in any suitable combination and location. Those skilled in the art will appreciate that other arrangements and elements (for example, machines, interfaces, functions, orders, and groupings of functions, etc.) can be used instead. Furthermore, various functions described as being performed by one or more elements can be carried out by a processor executing computer-readable program instructions from a computer readable medium and/or by any combination of hardware, firmware, and software.

First and second diagnostic devices 104, 106 may be any device capable of obtaining data from vehicle 102 under test useful in diagnosing a problem with the vehicle 102. For example, diagnostic devices 104, 106 may be any one of a data acquisition device (DAQ), a vehicle scanner, an engine analyzer, a gas/exhaust analyzer, a cooling system pressure tester, a thermometer, a battery analyzer, and a cylinder compression tester. Other diagnostic devices could also be used. In a preferred embodiment, first diagnostic device 104 is a data acquisition device (DAQ) and second diagnostic device 106 is a vehicle scanner. Although third diagnostic device 108 is illustrated as a display device in FIG. 1, in alternative embodiments, third diagnostic device 108 may take some other form.

DAQ 104 and vehicle scanner 106 may connect to vehicle 102 under test via wired links 112 and 114, respectively. The vehicle 102 may comprise an automobile, a motorcycle, a semi-tractor, farm machinery, or some other motorized vehicle. System 100 is operable to carry out a variety of functions, including functions for servicing the vehicle 102. The example embodiments may be used with any desired system or engine. Those systems or engines may comprise items utilizing fossil fuels, such as gasoline, natural gas, propane, and the like, electricity, such as that generated by battery, magneto, fuel cell, solar cell and the like, wind, and/or hybrids or combinations thereof. Those systems or engines may be incorporated into other systems, such as an automobile, a truck, a boat or ship, a motorcycle, a generator, an airplane and the like. DAQ 104 and vehicle scanner 106 may include batteries that provide operational power, or may receive operating power through their respective wired links 112 and 114 with vehicle 102 or some other external link. Furthermore, the embodiments described herein may include or be utilized with any appropriate voltage or current source, such as a battery, an alternator, a fuel cell, and the like, providing any appropriate current and/or voltage, such as about 12 Volts, about 42 Volts and the like.

Each of the DAQ 104, vehicle scanner 106, and display device 108 may create and/or maintain a wireless link with any of the other devices via respective wireless links 114, 116, and 118. The wireless links 114, 116, and 118 may operate via a same wireless protocol, or via different wireless protocols, the only limitation being that each pair of wirelessly communicating devices in FIG. 1 must both support a same particular wireless protocol to communicate.

Each of the one or more wireless links 114, 116, and 118 may be arranged to carry out communications according to an industry standard, such as an Institute of Electrical and Electronics Engineers (IEEE) 802 standard. The IEEE 802 standard may comprise an IEEE 802.11 standard for Wireless Local Area Networks (e.g., IEEE 802.11a, b, g, or n), an IEEE 802.15 standard for Wireless Personal Area Networks, an IEEE 802.15.1 standard for Wireless Personal Area Networks—Task Group 1, an IEEE 802.16 standard for Broadband Wireless Metropolitan Area Networks, or some other IEEE 802 standard. For purposes of this description, a wireless network arranged according to the IEEE 802.11 standard can be referred to as a Wi-Fi network, and a wireless network arranged according to the IEEE 802.15.1 can be referred to as a Bluetooth (BT) network. Other protocols could also or alternatively be used.

Each of the devices 104, 106, and 108 may transmit data and/or commands to one another via the wireless links 114, 116, and 118. As an example, display device 108 may establish a wireless link 116 with DAQ 104 and send an instruction to the DAQ 104 to switch to “voltmeter mode.” DAQ 104 may then respond by taking a voltage reading from the vehicle 102 and transmitting the voltage reading to display device 108.

Each of the devices 104, 106, and 108 will now be described in more detail. As set forth above, although in a preferred embodiment devices 104, 106, and 108 comprise a DAQ, vehicle scanner, and display device, respectively, other embodiments may comprise different devices performing different functions.

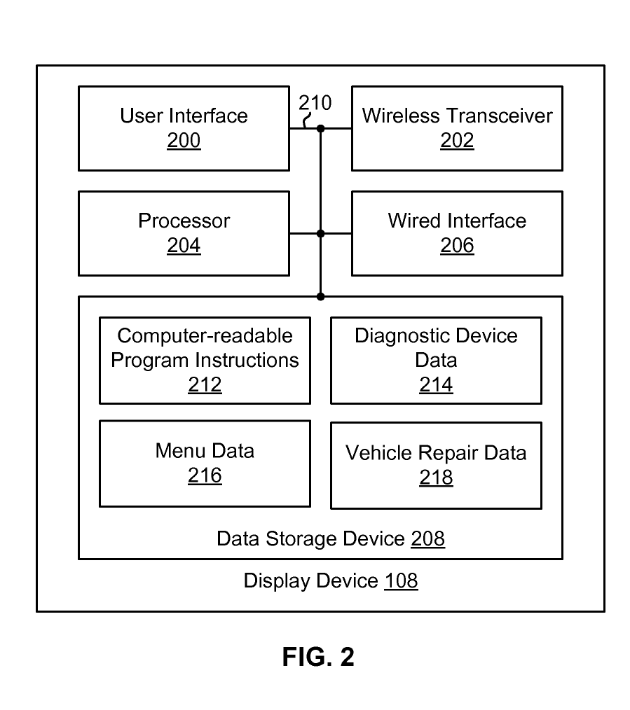

FIG. 2 is a block diagram of display device 108, which includes a user interface 200, a wireless transceiver 202, a processor 204, a wired interface element 206, and a data storage device 208, all of which may be linked together via a system bus, network, or other connection mechanism 210.

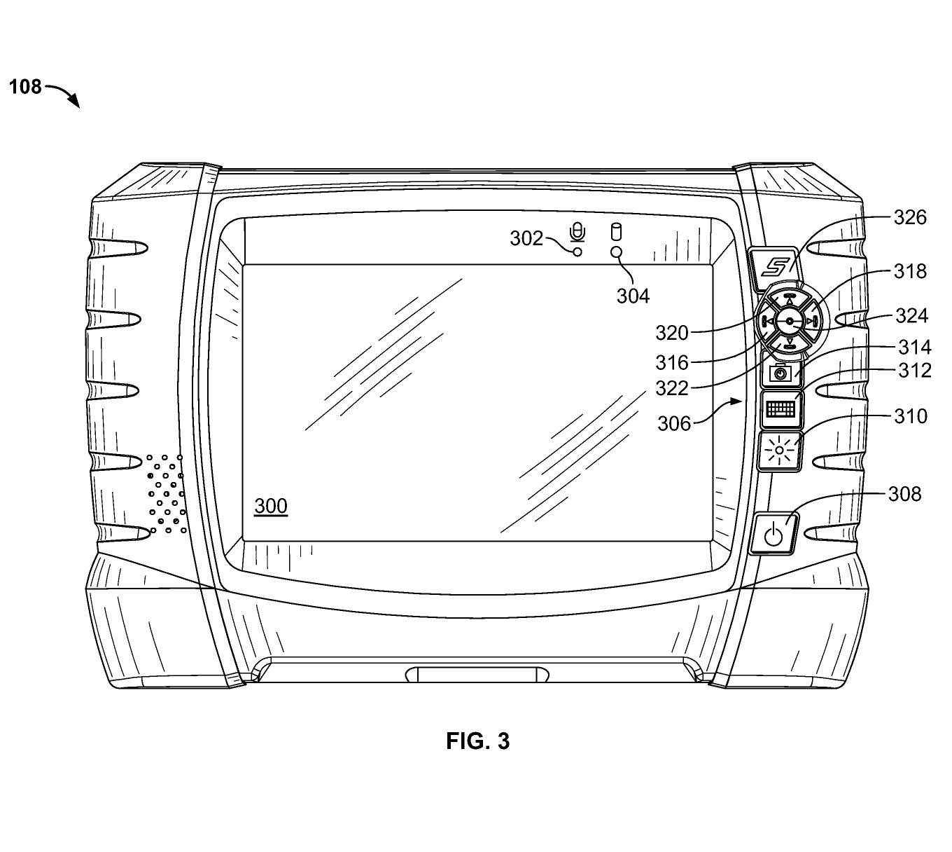

User interface 200 is operable to present data to a user and to enter user selections. User interface 200 may include a display 300 (illustrated in FIG. 3) that is operable to visually present input data transmitted to wireless transceiver 206 from vehicle scanner 106 or DAQ 104. Display 300 may also prompt a user to enter information, including for example, a password or some other information. Display 300 may also display input data received from multiple diagnostic devices, such as input data received from both DAQ 104 and vehicle scanner 106. Display 300 may display data stored at data storage device 208, such as menu data 216 or vehicle repair data 218. User interface 200 may further include an input selection element that is operable to enter a user selection. Further examples of input selection elements are illustrated in FIG. 3.

Wireless transceiver 202 comprises a wireless receiver and transmitter operable to carry out wireless communications with one or more of DAQ 104, vehicle scanner 106, and/or some other diagnostic device that is operating within wireless communication range of display device 108. As an example, wireless transceiver 202 may comprise a transceiver that is operable to carry out communications via a BT network. As another example, wireless transceiver 202 may comprise a transceiver that is operable to carry out communications via a Wi-Fi network. Other wireless communications protocols could also or alternatively be used, including, for example, WiMAX, Cellular, ZigBee, and Wireless USB, among others.

In accordance with an embodiment in which devices 104, 106, and 108 each include a single wireless transceiver (e.g., a BT transceiver), one of the devices, such as display device 108, may operate as a master device, and the other devices, such as DAQ 104 and vehicle scanner 106, may operate as slaves to the master. Vehicle scanner 106 and display device 108 may transmit communications via a wireless link 118 using, for example, a time-division duplex arrangement and synchronized to a clock signal of the master.

Wireless transceiver 202 is not limited to a single wireless transceiver. For example, wireless transceiver 202 may comprise a BT transceiver and a Wi-Fi transceiver. In accordance with such an example, the BT transceiver may communicate with DAQ 104 and/or vehicle scanner 106 via a BT network, and the Wi-Fi transceiver may communicate with DAQ 104 and/or vehicle scanner 106 via a Wi-Fi network.

In accordance with an embodiment in which display device 108 includes two transceivers (e.g., a BT transceiver and a Wi-Fi transceiver) and DAQ 104 and/or vehicle scanner 106 each include two transceivers (e.g., a BT transceiver and a Wi-Fi transceiver), DAQ 104 and/or vehicle scanner 106 may simultaneously transmit data to display device 108 for display via either one or both of the BT and Wi-Fi networks.

Each wireless transceiver of the example embodiments may operate in a transceiver-on-state. In the transceiver-on-state, the transceiver is powered on. While operating in the transceiver-on-state, the transceiver can transmit and receive data via an air interface. For some transceivers, while operating in the transceiver-on-state, the transceiver can transmit and receive data via the air interface simultaneously. For other transceivers, while operating in the transceiver-on-state, the transceiver can either transmit or receive data via the air interface at any given time. Each wireless transceiver of the example embodiments may also operate in a transceiver-off-state or low-power-state. While operating in the transceiver-off-state or low-power-state, the transceiver is powered off or in a low-power state and the transceiver refrains from transmitting and/or receiving data.

In the case of having a single transceiver, data received from one device may be buffered internally prior to transmitting the data to another different device. In the case of having two or more transceivers, data received from one device on a first transceiver may be routed to the second transceiver for transmission to the another different device concurrently with reception of additional data on the first transceiver.

Each wireless transceiver of the example embodiments may also operate to detect and monitor a wireless communications link with another device. As part of a wireless protocol, or otherwise, each transceiver may provide a periodic indication to another device that the another device may use to confirm the status of the wireless communication link. This indication may be, for example, transmitted data packets themselves or acknowledgement packets acknowledging receipt of prior communications. Alternatively, this indication may be a pulse broadcast (or “heartbeat”) that may comprise intermittent, periodic, or semi-periodic broadcasts of signals.

Wired interface 206 may include one or more wire-line ports. Each port provides an interface to display device 108 and to one or more circuits. In one respect, the one or more circuits may comprise electrical circuits, such as the electrical circuits of a Universal Serial Bus (USB®) port or the electrical circuits of an Ethernet port (e.g., a CAT 5 cable). In another respect, the one or more circuits may comprise optical fibers that are operable to carry optical signals. The Ethernet port, when properly enabled and connected, may connect display device 108 to other networks, such as local area networks (LANs) and wide area networks (WANs), such as the Internet. A server on the LAN or WAN may provide additional functionality to display device 108, and may provide, for example, information regarding registration and status of connected diagnostic devices and diagnostic devices attempting to connect with display device 108. Additionally, the server may be an authentication and tracking server that provides authentication and theft prevention services for diagnostic devices. Other examples of the one or more circuits are also possible. Although the remainder of the specification assumes that the wired interface 206 is used to access servers on the LAN/WAN, wireless transceiver 202 could alternatively be used.

Processor 204 may comprise one or more general purpose processors (e.g., INTEL microprocessors) and/or one or more special purpose processors (e.g., digital signal processors). Processor 204 may be configured to execute computer-readable program instructions (CRPI) 212 that are contained in computer-readable data storage device 208 and which cause the processor 204 to perform the functionality described below.

Data storage device 208 may comprise a computer-readable storage medium readable by processor 204. In the context of this document, a computer-readable medium is an electronic, magnetic, optical, or other physical device or means that can contain or store a computer program for use by, or in connection with, a computer related system or method. The methods can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. Data storage device 208 may contain various data including, but not limited to, CRPI 212, diagnostic device data 214, menu data 216, and/or vehicle repair data 218. For brevity in this description, CRPI are sometimes referred to as program instructions.

Diagnostic device data 214 may include data associated with a device that is arranged to communicate with display device 108 via one or more wireless communication links. For example, diagnostic device data 214 may include data associated with one of the DAQ 104 and vehicle scanner 106, such as a radio identifier, MAC address, security key, and/or password information. The associated data may be received at display device 108, for storing as diagnostic device data 214, during a pairing process carried out between display device 108 and the DAQ 104 and/or vehicle scanner 106. For example, the pairing process between vehicle scanner 106 and display device 108 may include vehicle scanner 106 providing display device 108 with the data associated with vehicle scanner 106 and display device 108 providing vehicle scanner 106 with data associated with display device 108. After carrying out the pairing process, display device 108 may use the stored diagnostic device data 214 in establishing the communication link 118 with vehicle scanner 106. The associated data in diagnostic device data 214 may also be used in communication with a remote authentication and tracking server to determine whether a corresponding diagnostic device is potentially stolen. Diagnostic device data 214 is not limited to data associated with one diagnostic device. In that regard, diagnostic device data 214 may also include data associated with DAQ 104 and other devices not illustrated in the figures.

Menu data 216 comprises data that can be visually presented via user interface 200. Menu data 216 may include, for example, icons and images that provide a user with a graphical representation of input and functionality options. Input elements may then be used to traverse the menu data 216 displayed on the display 300.

CRPI 212 may comprise program instructions that are executable by processor 204 to perform functions represented by the program instructions, such as operating system program instructions that provide for direct control and management of hardware components such as processor 204, data storage device 208, and user interface 200. The operating system can manage execution of other program instructions within CRPI 212. As an example, the operating system may comprise the Windows XP Embedded (XPe) operating system available from Microsoft Corporation, Redmond, Wash., United States. Other examples of operating system are also possible.

CRPI 212 may further comprise program instructions (referred to herein as PI-212-A) that are executable by processor 204 so as to cause display device 108 to operate as a peripheral manager (PM) that manages functions carried out by peripheral devices, such as DAQ 104 and vehicle scanner 106.

CRPI 212 may further comprise program instruction (referred to herein as PI-212-B) that are executable by processor 204 to cause the wireless transceiver 202 to transmit instructions or mode-selection commands to one or more of DAQ 104 and vehicle scanner 106. In one respect, an instruction mode-selection command may be addressed to a specific diagnostic device, such as DAQ 104. In another respect, the instruction or mode-selection command may be broadcast to any device within a transmission range of the wireless transceiver 202. In either respect, the instruction or mode-selection command may or may not include data that identifies the display device 108 as the source of the instruction or mode-selection command.

CRPI 212 may further comprise program instructions (referred to herein as PI-212-C) that are executable by processor 204 to execute any one or more of the functions disclosed herein, including for example, one or more of detecting a trigger, communicating with one or more of an authentication and tracking server and vehicle diagnostic devices, monitoring a status of one or more wireless links 116, 118, and executing an anti-theft response.

Next, FIG. 3 illustrates a front view of an example embodiment of display device 108 with which diagnostic devices 104, 106 may communicate. Display device 108 includes a display 300, a status indicator 304 (e.g., a light emitting diode (LED)), and user controls 306.

Display 300 may comprise a liquid crystal display (LCD), a plasma display, an electrophoretic display, or some other type of display. Display 300 is operable to visually present (e.g., display) data to a user, including, for example, vehicle diagnostic data transmitted to the display device 108 from a diagnostic device 104, 106. For purposes of this description, data displayed at display device 108 is referred to as “displayed data.” The data received and presented on the display 300 may take the form of an alphanumeric presentation, a graphical presentation, or some other type of presentation.

User controls 306 are operable to enter a user selection. User controls 306 may be arranged in various ways. In that regard, user controls 306 may be arranged to include a keypad, rotary switches, push buttons, or some other means to enter a user selection. As set forth in the example embodiment illustrated in FIG. 3, user controls 306 may include, among others, a power button 308, a brightness button 310, a keyboard button 312, a cursor left button 316, a cursor right button 318, a cursor up button 320, a cursor down button 322, a menu item selection button 324, and a quick access button 326. Table 1 lists example user selections that can be entered using user controls 306. Other examples of user controls 306 and other examples of user selections are also possible.

TABLE 1

| User Button | Example User Selection |
|---|---|
| Power button 308 | Turn display device 108 power on and off. |
| Brightness button 310 | Increase or decrease a brightness |
| | of display 300. |
| Keyboard button 312 | Display keyboard at display 300. |
| Cursor left button 316 | Move a cursor, displayed at display |
| | 300, to the left. |
| Cursor right button 318 | Move a cursor, displayed at display |
| | 300, to the right. |
| Cursor up button 320 | Move a cursor, displayed at display |
| | 300, upwards. |
| Cursor down button 322 | Move a cursor, displayed at display |
| | 300, downwards. |
| Menu item selection button 324 | Select a menu item from a displayed |
| | menu data. |
| Quick access button 326 | Select a function that pertains to a current |
| | operating mode of display device 108. |

User controls 306 may additionally serve as a means for entering a password to verify ownership of the display device 108 and/or unlock the display device 108. For example, a password entered into the display device 108 via user controls 306 may be transmitted to a remote authentication and tracking server via wired interface 206. The entered password may be transmitted to the server along with a device ID. Alternatively or additionally, the entered password may be used to unlock display device 108 after receiving a response from the server that the display device 108 may potentially be stolen. Other uses of user controls 306 are also possible.

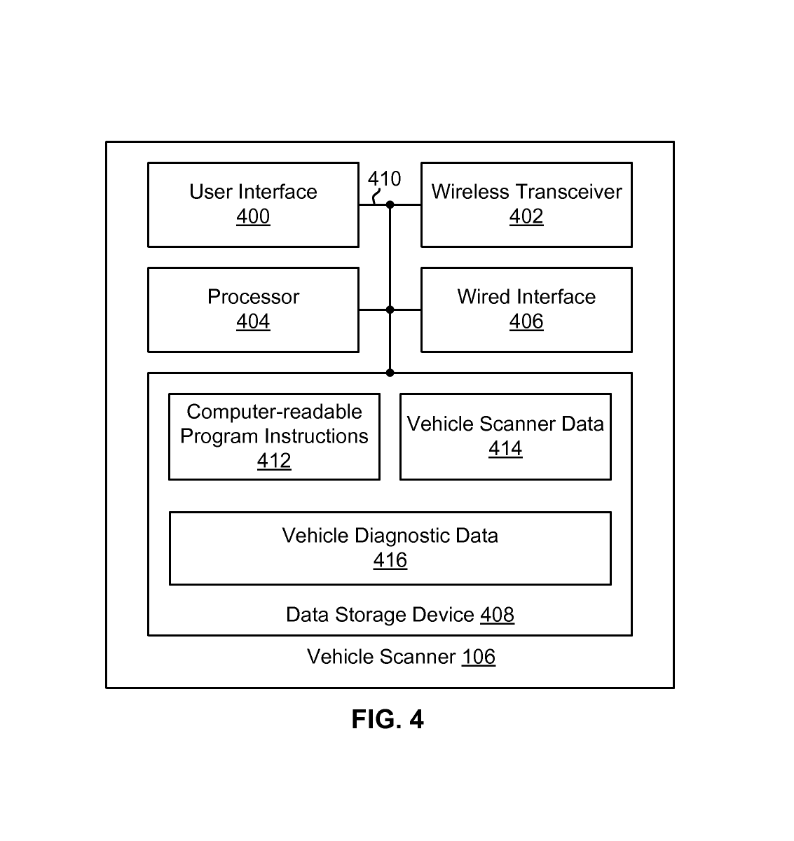

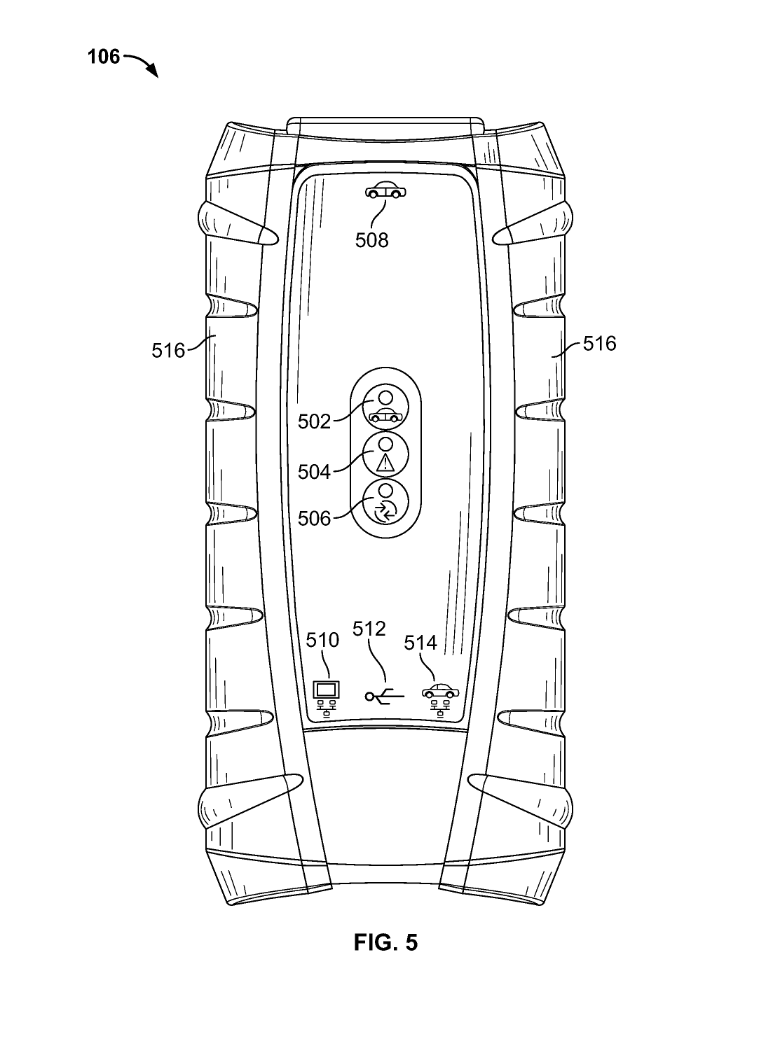

Next, FIG. 4 is a block diagram of a vehicle scanner diagnostic device 106, and FIGS. 5-7 illustrate two different views of the vehicle scanner 106. As illustrated in FIG. 4, vehicle scanner 106 includes a user interface 400, a wireless transceiver 402, a processor 404, a wired interface 406, and a data storage device 408, all of which may be linked together via a system bus, network, or other connection mechanism 410. User interface 400 is operable to present information to a user of vehicle scanner 106. Elements of user interface 400 are illustrated in FIG. 5. As set forth earlier, although in this preferred embodiment diagnostic device 106 is a vehicle scanner, in other embodiments, diagnostic device 106 may be some other diagnostic device.

Wireless transceiver 402 comprises a wireless receiver and transmitter operable to carry out wireless communications with one or more of DAQ 104, display device 108, and/or some other device that is operating within wireless communication range of vehicle scanner 106. As an example, wireless transceiver 402 may comprise a transceiver that is operable to carry out communications via a BT network. As another example, wireless transceiver 402 may comprise a transceiver that is operable to carry out communications via a Wi-Fi network.

Wireless transceiver 402 is not limited to a single wireless transceiver. For example, wireless transceiver 402 may comprise both a BT transceiver and a Wi-Fi transceiver. In accordance with such an example, the BT transceiver may communicate with display device 108 and/or DAQ 104 via a BT network, and the Wi-Fi transceiver may communicate with display device 108 and/or DAQ 104 via a Wi-Fi network.

In the case of having a single transceiver, data received from one device may be buffered internally prior to transmitting the data to another different device. In the case of having two or more transceivers, data received from one device on a first transceiver may be routed to the second transceiver for transmission to the another different device concurrently with reception of additional data on the first transceiver. In one embodiment, wireless transceiver 402 may maintain a wireless link 118 to display device 108, and may provide an indication of a potential theft attempt in response to detecting a break in the wireless link 118. Wireless transceiver 402 may also operate to provide display device 108 an identifier associated with vehicle scanner 106, such as a MAC address, security key, hardware ID, username, or some other identifier. Wireless transceiver 402 may also operate to transmit a password entered via user interface 400 to display device 108. Wireless transceiver 402 may be used for other functions as well.

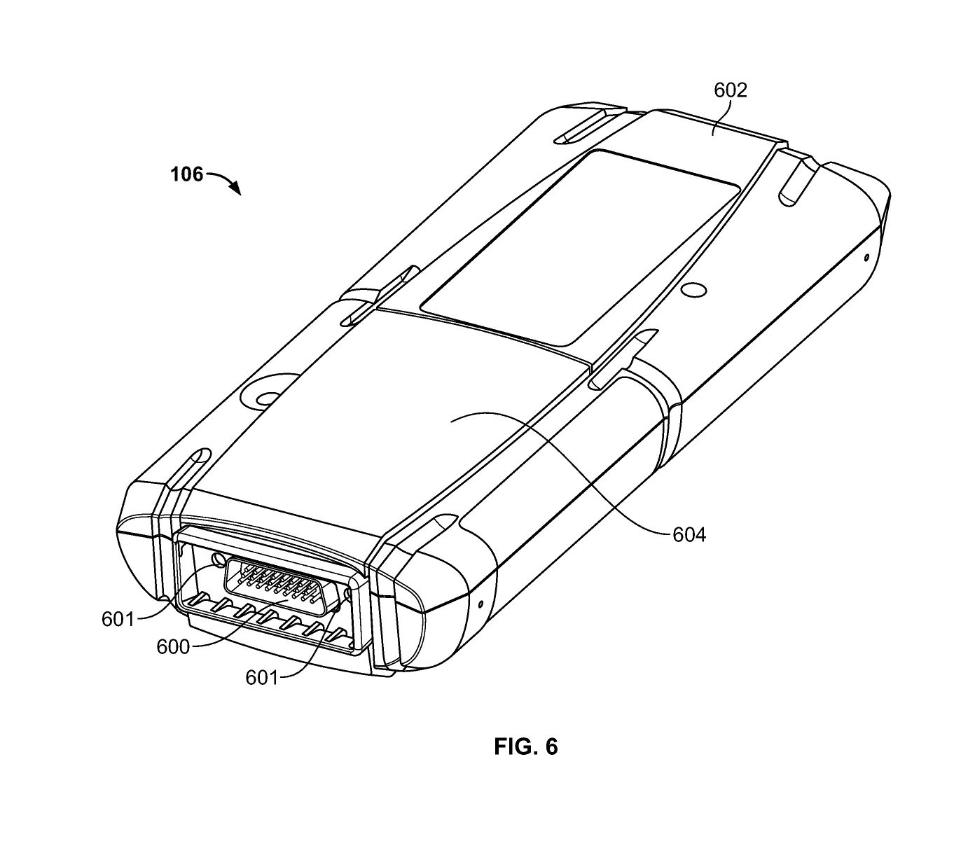

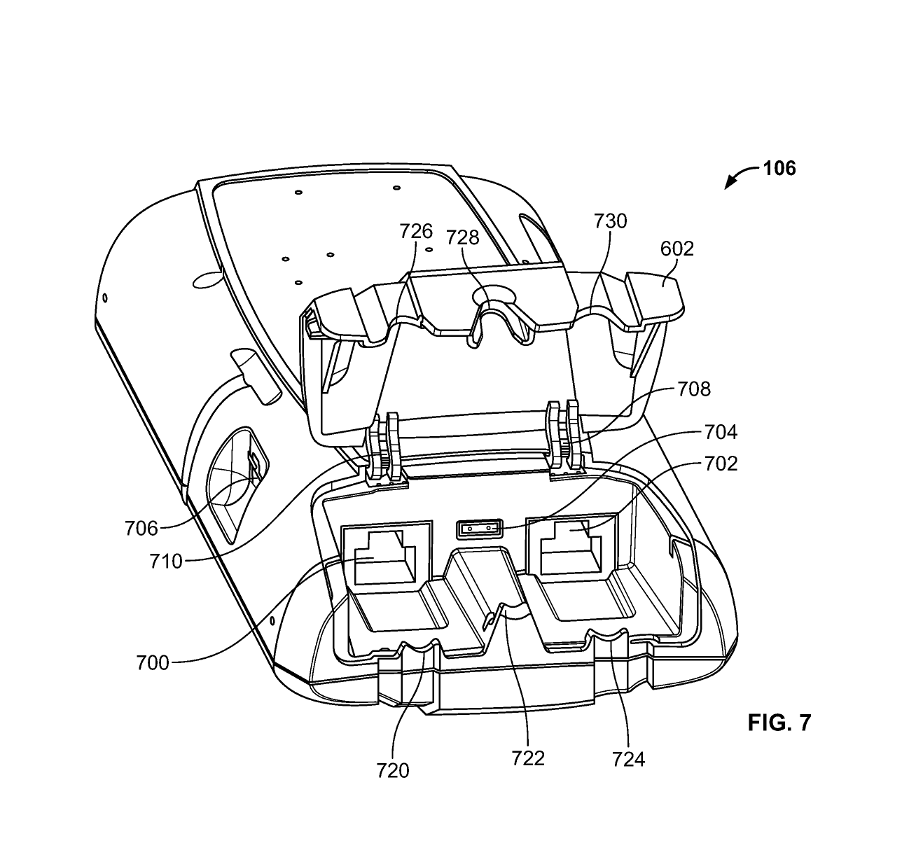

Wired interface 406 may comprise one or more wire-line ports. As an example, wired interface 406 may include wired ports 600 (illustrated in FIG. 6), ports 700, 702, and 704, and slot 706 (all illustrated in FIG. 7).

Wired interface 406 and/or wireless transceiver 402 may also operate to deliver an unlock instruction or key to vehicle scanner 106. For example, a specially formatted data packet may be transmitted to vehicle scanner 106 via wired interface 406 and/or wireless transceiver 402 to unlock a vehicle scanner 106 that has been locked due to a suspected theft.

Port 600 may be a vehicle interface port that communicatively connects the vehicle scanner 106 to the vehicle 102 via wired link 112. In that regard, wired link 112 may comprise a vehicle interface cable having two cable ends. A first cable end of the vehicle interface cable may include a connector that is connectable to and removable from port 600. A second cable end of the vehicle interface cable may include a connector that is connectable to and removable from a connector in the vehicle 102. The connector interface in the vehicle 102 may be arranged according to a particular connector standard, such as Society of Automotive Engineers (SAE) specification J-1962 or some other connector standard.

Ports 700 and 702 may comprise respective Ethernet ports. Each Ethernet port may communicatively connect to a first end of a respective Ethernet cable. A second end of a respective Ethernet cable may connect to an Ethernet port directly or indirectly connected to a local or wide area network (such as the Internet). Another respective Ethernet cable may connect the vehicle scanner 106 to the display device 108 via a corresponding Ethernet port provided on the display device 108. Ethernet ports 700 and 702 may additionally provide a path for upgrading internal program code within the vehicle scanner 106, such as upgrading CRPI 412.

Port 704 may comprise a USB port. The USB port 704 may communicatively connect to a first end of a USB cable (not shown). A second end of the USB cable may connect to a corresponding USB port provided on the display device 108. Alternatively, USB port 704 may connect the vehicle scanner 106 to a personal digital assistant (PDA) device. In this mode, the PDA may act as a USB master and provide instructions to and receive data from, the vehicle scanner 106. Further, in the event that a mass storage device (such as a flash memory stick) is plugged into the USB port 704, USB port 704 may provide data storage in addition to or in place of data storage device 408.

Slot 706 may be a memory card slot that allows additional storage capacity to be added to the vehicle scanner device 106 by insertion of a corresponding memory card, and/or allows propriety diagnostic programs to be loaded via memory card. The slot 706 may be accessible after removing the grips 516 from the sides of the vehicle scanner 106.

Wired interface 406 may further include a configurable set of switches and circuits in communication with port 600 in order to configure port 600 to properly communicate with a particular vehicle 102 under test. More specifically, because different makes and models of vehicles 102 utilize different signaling standards on their respective diagnostic port, wired interface 406 may include circuits and switches that allow the single port 600 to interface with a varying set of vehicle diagnostic port standards. For example, under the OBD II standard umbrella, signaling interfaces compliant with SAE J1850 PWM, SAE J1850 VPW, ISO 9141-2, ISO 14230 KWP2000, and ISO 15765 CAN could all potentially be used on vehicle 102. Switch information may be stored locally in data storage device 408 and, in response to receiving vehicle information from display device 108, processor 404 may retrieve and use the information to set switches and circuits to match the required signaling standard. Alternatively or additionally, vehicle scanner 106 may receive circuit and switch instructions via wireless transceiver 402 and/or wired interface 406 from display device 108 or from some other device.

Processor 404 may comprise one or more general purpose processors (e.g., INTEL microprocessors) and/or one or more special purpose processors (e.g., digital signal processors). Processor 404 may be configured to execute CRPI 412 that are contained in computer-readable data storage device 408 and which cause the processor 404 to perform the functionality described below.

Data storage device 408 may comprise a computer-readable storage medium readable by processor 404. Data storage device 408 may contain various data including, but not limited to, CRPI 412, vehicle scanner data 414, and vehicle diagnostic data 416. CRPI 412 may comprise program instructions for carrying out any one or more of the vehicle scanner 106 functions herein described. Vehicle scanner data 414 may include switch settings for configuring wired interface 406 or commands/data received from display device 108, for configuring wired interface 406 and communicating with the vehicle 102. Vehicle scanner data 414 may further comprise an identifier associated with vehicle scanner 106 for transmission to display device 108, and/or a pre-stored password for comparison to an entered password to unlock vehicle scanner 106.

Vehicle scanner data 414 may further include data associated with a device that is arranged to communicate with vehicle scanner 106 via one or more wireless communication links. For example, vehicle scanner data 414 may include data associated with one of the DAQ 104 and display device 108, such as a radio identifier, MAC address, security key, and/or password information. The associated data may be received at vehicle scanner 106, for storing as vehicle scanner data 414, during a pairing process carried out between display device 108 and the vehicle scanner 106, or between the DAQ 104 and the vehicle scanner 106. For example, the pairing process between vehicle scanner 106 and display device 108 may include vehicle scanner 106 providing display device 108 with the data associated with vehicle scanner 106 and display device 108 providing vehicle scanner 106 with data associated with display device 108. After carrying out the pairing process, vehicle scanner 106 may use the stored pairing data in establishing the communication link 118 with display device 108. Vehicle scanner data 414 may also include data associated with DAQ 104 and other devices not illustrated in the figures.

Vehicle diagnostic data 416 may also comprise data received from the vehicle 102, including for example, sensor data or error code data.

Data storage device 408 may comprise permanent internal storage comprised of, for example, magnetic or semiconductor-based memory, and/or may comprise a removable memory device, such as a flash card or USB memory stick, or may comprise a combination of the above. Data storage device 408 may alternatively or additionally comprise a removable card or stick inserted into one or more of USB port 1308 and/or a memory card inserted into memory card slot 1306. Other types of storage could also be used.

Next, FIG. 5 illustrates a front view of an example embodiment of vehicle scanner 106. As set forth in FIG. 5, the front face of vehicle scanner 106 includes visual indicators 502-514 and side grips 516. Visual indicators 502, 504, and 506, which may be part of user interface 400, may comprise respective light emitting diodes (LEDs) or some other visual indictor that is operable to convey information to a user. Data storage device 408 may include CRPI executable by processor 404 to turn visual indicators 502, 504, and 506 on and off to reflect a corresponding status of the vehicle scanner 106.

Visual indicator 502 may turn on to indicate that vehicle scanner 106 is receiving electrical power from vehicle 102. Because vehicle scanner 106 may not include its own power source, it may rely upon vehicle 102 to provide it with operating power via vehicle interface port 600. If visual indicator 502 fails to light after connecting vehicle scanner 106 to the vehicle 102, a repair technician may know to test the vehicle's electrical system. Absent another power source, such as a local battery power source, vehicle scanner 106 may fail to operate. Alternatively, vehicle scanner 106 may be provided with a battery to allow operation without being connected to the vehicle's power supply.

Visual indicator 504 may turn on and off in a periodic manner so as to flash (e.g., turn on for 1 second and then turn off for 1 second). In particular, visual indicator 504 may flash in specific sequences so as to identify any of a variety of diagnostic or error codes. The diagnostic codes, for example, could pertain to (i) an error in the vehicle 102, (ii) an error within the vehicle scanner 106, (iii) an error communicating with display device 108, or (iv) or some other error/status. As an example, visual indicator 502 may flash 3 times, wait, and then flash 2 more times, so as to visually present a diagnostic code of 32, which could imply that a wireless connection with display device 108 has failed or that no network path to display device 108 can be found.

Visual indicator 506 may turn on to indicate that vehicle scanner 106 is carrying out communications with vehicle 102. More specifically, visual indicator 506 may turn on to indicate that vehicle scanner 106 is presently carrying out communications with at least one electronic control unit (ECU) within the vehicle 102, and visual indicator 506 may turn off to indicate that vehicle scanner 106 is not presently carrying out communications with at least one ECU within the vehicle 102.

Visual indicator 508 is an orientation indicator, providing an indicator to a repair technician of which side of the vehicle scanner 106 the vehicle connector port 600 can be found (See FIG. 6).

Visual indicators 510 and 514 are communication port activity indicators, and provide an indication of communications activity on the respective Ethernet ports 700 and 702 (See FIG. 7). Visual indicators 510 and 514 may flash with a periodic intensity relative to a rate of data being communicated over Ethernet ports 700 and 702. Visual indicator 512 is another communication port activity indicator, but instead provides an indication of communications activity on the USB port 704 (See FIG. 7). Visual indicator 512 may light up when a USB cable is present and properly connects vehicle scanner 106 to another active device, such as display device 108 or a PDA device. Other methods of providing visual indicators are also possible.

Although not shown, any one of the visual indicators noted above could be replaced by an audio indicator. For example, visual indicator 504 could be replaced with a speaker (or with an audio jack for connecting some other device that converts electrical signals into audio signals) that emits a continuous or periodic audio tone to indicate a corresponding diagnostic or error code.

Furthermore, each of visual indicators 502-514 may operate as an input button element, such that depression of the respective visual indicator 502-514 generates a signal or interrupt to processor 404. In this manner, visual indicators 502-514 may operate as a password entry system, allowing an owner/operator to verify ownership of the vehicle scanner 106 and/or unlock a vehicle scanner 106 that has been locked due to an indication that the device is suspected to be stolen, perhaps by entering a particular combination of input button elements.

Grips 516 are arranged along the two longitudinal ends of the vehicle scanner, and may function to keep access port cover 602 (See FIG. 7) closed and to provide shock absorption in the event that the vehicle scanner 106 is dropped or struck. Grips 516 may be formed as a single piece of rubber connected along a rear or end of the vehicle scanner 106, or may be formed as two separate pieces of rubber. Materials other than rubber could alternatively be used. Grips 516 may be removed away from the vehicle scanner to open access port cover 602 and/or access slot 706.

FIG. 6 is a perspective view of the rear face of the vehicle scanner 106 with grips 516 removed and illustrates vehicle interface port 600, connector mounting holes 601, access port cover 602, and upper cover 604. Port 600 may include a high-density-26 (HD-26) connector, but is not so limited. An HD-26 connector may include 26 male or female connector terminals. Port 600 is arranged to facilitate a wire-line connection to vehicle 102 via wired link 112. Wired link 112 may comprise a cable that includes fasteners that are arranged to fasten one end of the cable to vehicle scanner 106 via connector mounting holes 601. The other end of the cable may include similar fasteners to rigidly secure the cable to the vehicle's diagnostic port.

Upper cover 604 may cover, and provide access to when removed, an expansion port that allows the functionality of the vehicle scanner 106 to be upgraded and/or revised. An expansion circuit board may comprise, for example, a printed circuit board (PCB) containing a plurality of discrete circuit elements and/or one or more integrated circuits (ICs). Various expansion circuit boards may be interfaced with vehicle scanner 106 to provide additional and/or more robust functionality without the need to manufacture an entirely new vehicle scanner 106 device.

FIG. 7 illustrates a vehicle scanner 106 with its access port cover 602 placed in an open position. As set forth in FIG. 7, access port cover 602 may be hingedly attached to the vehicle scanner 106 via hinges 708 and 710. Hinges 708 and 710 are rotatable so as to allow port access cover 602 to move from the open position to the closed position and from the closed position to the open position. Channels 720-724 formed in a bottom surface of the vehicle scanner 106 and corresponding channels 726-730 formed in the access port cover 602 form cable openings when access port cover 602 is in the closed position and allow cables to exit the vehicle scanner 106 while the access port cover 602 is in the closed position.

While the access port cover 602 is open, access is provided to Ethernet ports 700 and 702 and USB port 704. In alternative embodiments, the ports accessible via access port cover 602 may include a different quantity, or may include different types of ports, including, for example, Firewire and/or eSATA ports. Vehicle scanner 106 may include a respective cable opening for each port accessible via access port cover 602. Alternatively, one or more cable openings may allow multiple cables to pass through access port cover 602.

A memory card inserted in memory card slot 706 may provide the data storage 408 for vehicle scanner 106, or may provide removable data storage in addition to separate data storage 408 provided permanently inside vehicle scanner 106. A memory card for insertion in the memory card slot 706 may include, for example, a Compact Flash card, an SD memory card, a mini SD memory card, an xD card, or other type of memory card. Whether a memory card inserted in memory card slot 706 comprises the data storage 408 or an alternative data store, the memory card may provide CRPI for execution by processor 404 of the vehicle scanner 106. The removable memory card may also provide storage space for storage of vehicle diagnostic data 416, in place of data storage device 408, or in addition to data storage device 408. Additionally, the memory card slot 706 may provide a means for delivering an unlock instruction or key to vehicle scanner 106. For example, a specially formatted memory card, or a specially formatted data packet stored on a memory card, may in response to being inserted into memory card slot 706, cause the diagnostic device to unlock after having been locked due to a suspected theft. Other means of unlocking a locked device may also be provided.

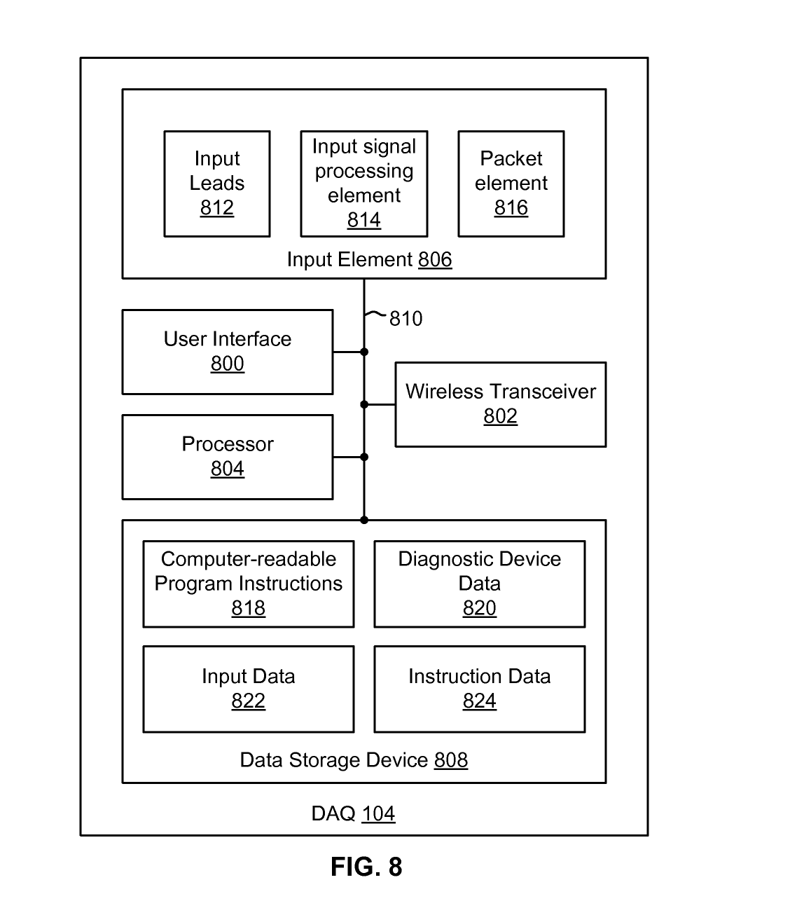

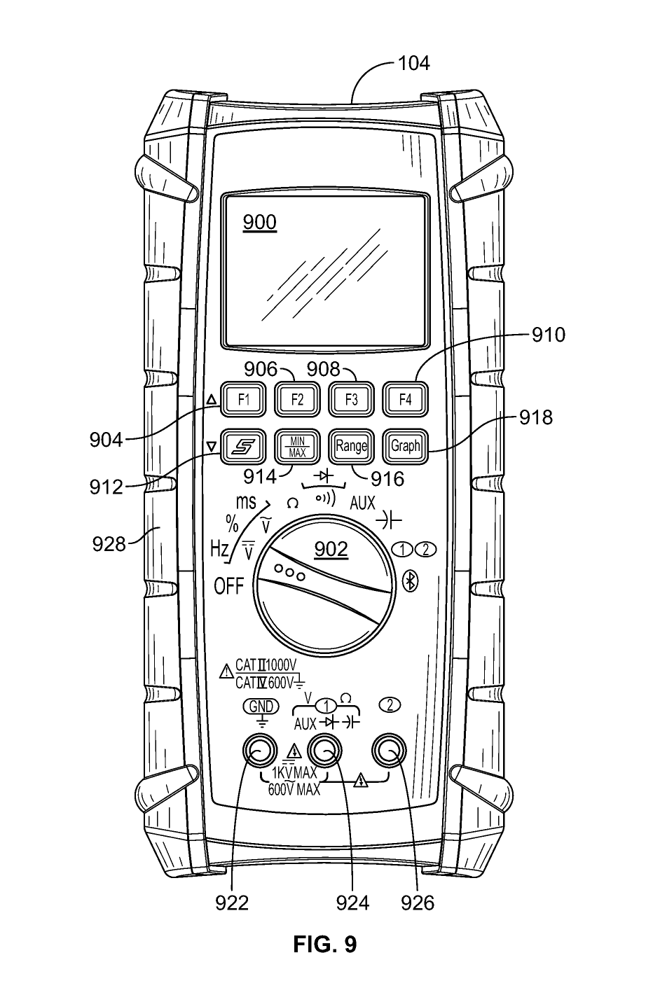

Next, FIG. 8 illustrates a block diagram of DAQ 104, and FIG. 9 illustrates details of an example embodiment of DAQ 104. As set forth earlier, although in this preferred embodiment diagnostic device 104 is a DAQ, in other embodiments, diagnostic device 104 may be some other diagnostic device. As illustrated in FIG. 9, DAQ 104 includes a user interface 800, a wireless transceiver 802, a processor 804, an input element 806, and a data storage device 808, all of which may be linked together via a system bus, network, or other connection mechanism 810. DAQ 104 may be configured to take measurements from the vehicle 102, including, for example, direct current (DC) voltage readings, alternating voltage (AC) voltage readings, and/or resistance readings. The DAQ 104 may also provide test modes such as a diode test/continuity test mode and a capacitance test mode. Other functions may also be provided.

User interface 800 is operable to present data to a user and to allow a user to enter selections (e.g., mode selections and sub-mode selections). User interface 800 may include a display 900 that is illustrated in FIG. 9. Display 900 is operable to visually present data, such as data obtained and/or generated by input element 806, data obtained via wireless transceiver 802, and/or data contained in data storage device 808. User interface 800 may include a mode selector for selecting one or more modes and/or sub-modes of DAQ 104. Example mode selectors 902, 904, 906, 908, 910, 912, 914, 916, and 918 are illustrated in FIG. 9.

Wireless transceiver 802 may comprise a single wireless transceiver that is operable to carry out communications via communications links 114, 116. Wireless transceiver 802 may carry out communications with vehicle scanner 106, display device 108, and/or some other device that is operating within a wireless communications range of DAQ 104. As an example, wireless transceiver 802 may comprise a BT transceiver, a Wi-Fi transceiver, or some other type of wireless transceiver.

Alternatively, wireless transceiver 802 may comprise multiple wireless transceivers. For example, wireless transceiver 802 may comprise two wireless transceivers that communicate according to a common air interface protocol or different air interface protocols. Those air interface protocols may be selected from a BT air interface protocol, a Wi-Fi air interface protocol, and some other air interface protocol. In accordance with an embodiment in which wireless transceiver 802 includes two transceivers, a BT transceiver may communicate with vehicle scanner 106 and/or display device 108 via a BT network, and a Wi-Fi transceiver may communicate with vehicle scanner 106 and/or display device 108 via a Wi-Fi network.

In one embodiment, wireless transceiver 802 may maintain a wireless link 116 to display device 108, and may provide an indication of a potential theft attempt in response to detecting a break in the wireless link 116. Wireless transceiver 802 may also operate to provide display device 108 an identifier associated with DAQ 104, such as a MAC address, hardware ID, username, or some other identifier. Wireless transceiver 802 may also operate to transmit a password entered via user interface 800 to display device 108.

Wireless transceiver 802 may operate to deliver an unlock instruction or key to DAQ 104. For example, a specially formatted data packet may be transmitted to DAQ 104 via wireless transceiver 802 to unlock a DAQ 104 that has been locked due to a suspected theft.

Processor 804 may comprise one or more general purpose processors (e.g., INTEL microprocessors) and/or one or more special purpose processors (e.g., digital signal processors). Processor 804 may execute CRPI 818 that are contained in computer-readable data storage device 808.

Input element 806 may include (i) one or more input leads 812, (ii) an input signal processing element 814 that is operable to convert input signals obtained via input leads 812 into input data, and (iii) a packet-element 816. Each input lead 812 is operable to receive input signals from an input signal acquisition point. The input signal acquisition point may comprise any of a variety of locations at which an input signal can be acquired. In accordance with an example, the input signal acquisition point may comprise a location on the vehicle 102 at which a voltage signal, current signal, air pressure signal, air temperature signal, oil pressure signal, oil temperature signal, exhaust composition signal, or some other input signal can be acquired.

Each input lead 812 may include a first end and a second end. The first end of each input lead 812 may be inserted into or otherwise attached to DAQ 104. The first end of each input lead may comprise a banana plug screw. The second end of each input lead 812 may be arranged in any of a variety of configurations. As an example, a configuration of the second end may comprise a configuration that includes (i) an alligator clip, such as an MTA85 alligator clip sold by Snap-on Incorporated, Kenosha, Wis., United States, (ii) a spring hook, such as an MTA80 spring hook sold by Snap-on Incorporated, (iii) a test probe, such as an MTA20 test probe sold by Snap-on Incorporated, or (iv) a backprobe, such as an MTTL7005 backprobe sold by Snap-on Incorporated. Other example configurations of the second end of an input lead 812 are also possible.

Input element 806 may include an input signal processing element 814 that is operable to convert an input signal received via one or more input leads 812 into data that is displayable at display 900. As an example, input signal processing element 814 may include an analog-to-digital converter.

Packet-element 816 may be operable to packetize the input data (e.g., place the input data into data packets) so as to generate data packets containing the input data. Packet-element 816 may provide the data packets to wireless transceiver 802 via connection mechanism 810 for subsequent transmission of the data packets via an air interface. In an alternative embodiment, processor 804 or some other portion of DAQ 104 can comprise packet-element 816 or carry out the functions of packet-element 816.

Data storage device 808 may comprise a computer-readable storage medium readable by processor 804. The computer-readable storage medium may comprise volatile and/or non-volatile storage components, such as optical, magnetic, organic or other memory or disc storage, which can be integrated in whole or in part with processor 804. Data storage device 808 may contain various computer-readable data, such as CRPI 818, diagnostic device data 820, input data 822, and instruction data 824.

Diagnostic device data 820 may include data associated with a device that is arranged to communicate with DAQ 104 via a wireless network. For example, diagnostic device data 820 may include data associated with display device 108, such as a radio identifier and password associated with display device 108. The data associated with display device 108 may be received at DAQ 104, for storing as diagnostic device data 820, during a pairing process carried out between display device 108 and DAQ 104. The pairing process between DAQ 104 and display device 108 may include DAQ 104 providing display device 108 with the data associated with DAQ 104 and display device 108 providing DAQ 104 with data associated with display device 108. After carrying out the pairing process with display device 108, DAQ 104 may use the diagnostic device data 820 when establishing communication link 116 with display device 108.

Diagnostic device data 820 is not limited to data associated with one diagnostic device. In that regard, diagnostic device data 820 may include respective data associated with each of a plurality of devices, including, for example, data associated with vehicle scanner 106. The data associated with vehicle scanner 106 may include a radio identifier and password associated with vehicle scanner 106. The data associated with vehicle scanner 106 may be received at DAQ 104, for storing as diagnostic device data 820, during a pairing process carried out between DAQ 104 and vehicle scanner 106. The pairing process between DAQ 104 and vehicle scanner 106 may include vehicle scanner 106 providing DAQ 104 with the data associated with vehicle scanner 106 and DAQ 104 providing vehicle scanner 106 with data associated with DAQ 104. After carrying out the pairing process with vehicle scanner 106, DAQ 104 may use the diagnostic device data 820 when establishing wireless communications link 114 with vehicle scanner 106.

Diagnostic device data 820 may further comprise an identifier associated with DAQ 104 for transmission to display device 108, and/or a pre-stored password for comparison to an entered password to unlock DAQ 104.

Input data 822 may comprise data generated by input signal processing element 814. A portion of data storage device 808 that contains input data 822 may function as a buffer to store input data for display on display 900 and/or for transmission to display device 108 via wireless communications link 116.

Instruction data 824 may comprise data that identifies how to connect a portion of the DAQ 104 to vehicle 102, how to operate vehicle 102, inspections to carry out on vehicle 102, or some other instruction data. Instruction data 824 may comprise various data including numbers, letters, punctuation marks, pictures, graphs, or some other visually presentable form of data.

CRPI 818 may include program instructions (referred to herein as PI-818-A) that are executable to change an operating state of wireless transceiver 802. Processor 804 may execute PI-818-A in response to mode selector 902 (illustrated in FIG. 9) changing between a local-control mode and a remote-control mode. Execution of PI-818-A may cause a transceiver or transceivers of wireless transceiver 802 to transition to a transceiver-on-state in response to mode-selector 902 changing to a remote-control mode from a local-control mode. Similarly, execution of PI-818-A may cause a transceiver or transceivers of wireless transceiver 802 to transition to a transceiver-off-state in response to mode-selector 902 changing to a local-control mode from a remote-control mode.

CRPI 818 may also include program instructions (referred to herein as PI-818-B) that are executable to determine a desired mode for DAQ 104 responsive to receiving a mode selection command from display device 108. If DAQ 104 is operating in the desired mode as indicated in the mode selection command, execution of PI-818-B allows DAQ 104 to continue operating in the desired mode. On the other hand, if DAQ 104 is operating in a mode different than the desired mode as indicated in the mode selection command, execution of PI-818-B causes DAQ 104 to transition to the desired mode.

CRPI 818 may further include program instructions (referred to herein as PI-818-C) that are executable to cause display 900 to display instruction data. In one respect, execution of PI-818-C may cause display 900 to display instruction data 824 so as to guide a repair technician in connecting input leads 812 to vehicle 102. In another respect, execution of PI-818-C may cause display 900 to display instruction data (such as instruction data 218) that is received from display device 108 via transceiver 802.

CRPI 818 may further comprise program instructions (referred to herein as PI-818-D) that are executable by processor 804 to execute any one or more of the functions disclosed herein, including for example, one or more of communicating a diagnostic device identifier to display device 108, monitoring a status of a wireless link 116, detecting a break in wireless link 116, and executing an anti-theft response. Other functions are possible as well.

Next, FIG. 9 illustrates a front view of the example embodiment of DAQ 104, and in particular, elements of user interface 800 and input element 806 from FIG. 8. As set forth above, elements of user interface 800 may include display 900 and mode selectors 902, 904, 906, 908, 910, 912, 914, 916, and 918. Elements of input element 806 may include ports 922, 924, and 926.

Display 900 may comprise a liquid crystal display (LCD), a plasma display, an electrophoretic display, or some other type of display. Display 900 is operable to visually present (e.g., display) data to a repair technician. Display 900 may visually present data using numbers, letters, punctuation marks, pictures, graphs, or some other visually presentable form of data. The data visually presented at display 900 may include locally-acquired data (LAD), such as data acquired via input element 806 (e.g., via input leads 812) and/or data contained in data storage device 808. The data visually presented at display 900 may include remotely-acquired data (RAD), such as data acquired via wireless transceiver 802 from one or more of display device 108 and vehicle scanner 106. Display 900 may also be used to prompt a user to enter a password, and or to provide an indication that DAQ 104 has been identified as being potentially stolen, among other things.

Mode selector 902 comprises a switch having multiple mode-positions. Mode selector 902 may comprise a rotary switch having nine mode-positions, but is not so limited. Each mode-position of mode selector 902 is associated with one or more modes (e.g., an off mode, a voltmeter mode, an ammeter mode, and a remote control mode, to name a few), and each of the mode-positions may be associated with one or more symbols that identify the mode(s) associated with that mode-position. Table 2 provides an example list of modes associated with each mode-position of mode selector 902, and an example list of whether each mode is a local-control mode (e.g., a mode selected by mode selector 902) or a remote-control mode (e.g., a mode selected by display device 108).

TABLE 2

| Mode-position | Mode Control Type | Mode |
|---|---|---|
| 1 | Local-Control | Off |
| 2 | Local-Control | DC Voltmeter mode |
| 3 | Local-Control | AC Voltmeter mode |
| 4 | Local-Control | Ohm-meter mode |
| 5 | Local-Control | Diode/Continuity Test mode |
| 6 | Local-Control | Auxiliary mode |
| 7 | Local-Control | Capacitance mode |
| 8 | Local-Control | Oscilloscope mode |
| 9 | Remote-Control | Various modes |

Mode-position 1 is associated with the symbol “OFF.” The mode-position numbers increase in a clockwise direction. The three circles on mode selector 902 are closest to a currently-selected mode position. In FIG. 9, mode-position 2 (DC Voltmeter mode) is the currently-selected mode-position.

Mode selector 902 may be turned to each of the nine mode-positions. Turning mode selector 902 from a first mode-position (not necessarily mode-position 1) to a second mode-position (not necessarily mode-position 2) causes DAQ 104 to transition from a first mode that is associated with the first mode-position to a second mode that is associated with the second mode-position. Transitioning from the first mode to the second mode may be carried out, at least in part, by processor 804 executing program instructions of CRPI 818.

Transitioning from a local-control mode to a remote-control mode may cause wireless transceiver 802 to transition from the transceiver-off-state to the transceiver-on-state. Processor 804 may execute IP-818-A in response to detecting mode selector 902 changing to a remote-control mode from a local-control mode.

Conversely, transitioning from a remote-control mode to a local-control mode may cause wireless transceiver 802 to transition from the transceiver-on-state to the transceiver-off-state. Processor 804 may execute IP-812-A in response to detecting mode selector 902 changing to a local-control mode from a remote-control mode.

While mode selector 902 is positioned at a mode-position corresponding to a remote-control mode, wireless transceiver 802 may receive a mode-selection command from display device 108. The mode-selection command may be unsolicited or may be received in response to wireless transceiver 802 transmitting to display device 108 a request for a mode-selection command. The mode-selection command received at wireless transceiver 802 may include a mode field that identifies a desired local-control mode that is selectable via mode selector 902. The mode field may also identify a sub-mode that is selectable via one of mode selectors 904, 906, 908, 910, 912, 914, 916, and 918 when mode selector 902 is in a local-control mode position.

Mode selectors 904, 906, 908, 910, 912, 914, 916, and 918 may each comprise a respective push button, but are not so limited. Pushing or pushing and releasing one of those mode selectors may cause DAQ 104 to transition to a mode and/or sub-mode associated with that mode selector. One or more of mode selectors 904, 906, 908, 910, 912, 914, 916, and 918 may be associated with multiple modes and/or multiple sub-modes. For example, mode selectors 904, 906, 908, and 910 may be associated with a respective first sub-mode while mode selector 902 is positioned at mode-position 2 and may be associated with a second different sub-mode while mode selector 902 is positioned at mode-position 3. One or more of mode selectors 904, 906, 908, 910, 912, 914, 916, and 918 may be associated with a remote-control mode. For instance, mode selector 904 may associated with a remote-control mode. In that regard, pushing or pushing and releasing mode selector 904 may cause DAQ 104 to transition from a local-control mode to a remote-control mode in the same way as if mode selector 902 was moved to mode-position 9.

Mode selectors 902, 904, 906, 908, 910, 912, 914, 916, and 918 may additionally operate as a password entry system, allowing an operator to verify ownership of the DAQ 104 and/or unlock a device that has been locked due to an indication that the DAQ 104 is suspected to be stolen by entering a particular combination of mode selectors.

Ports 922, 924, and 926 may be operable to receive a respective input lead. Each input lead can include first and second ends. The first end of an input lead may comprise a banana plug. Ports 922, 924, and 926 may include a respective female banana connector for receiving the banana plug of an input lead. The second end of each input lead may include an alligator clip, a quick-attach probe, or some other device for contacting an input signal acquisition point.

Grips 928 are arranged along the two longitudinal ends of the DAQ 104, and provide shock absorption in the event that the DAQ 104 is dropped or struck. Grips 928 may be formed as a single piece of rubber connected along a rear or end of the DAQ 104, or may be formed as two separate pieces of rubber. Materials other than rubber could alternatively be used.

### II. Example Operation

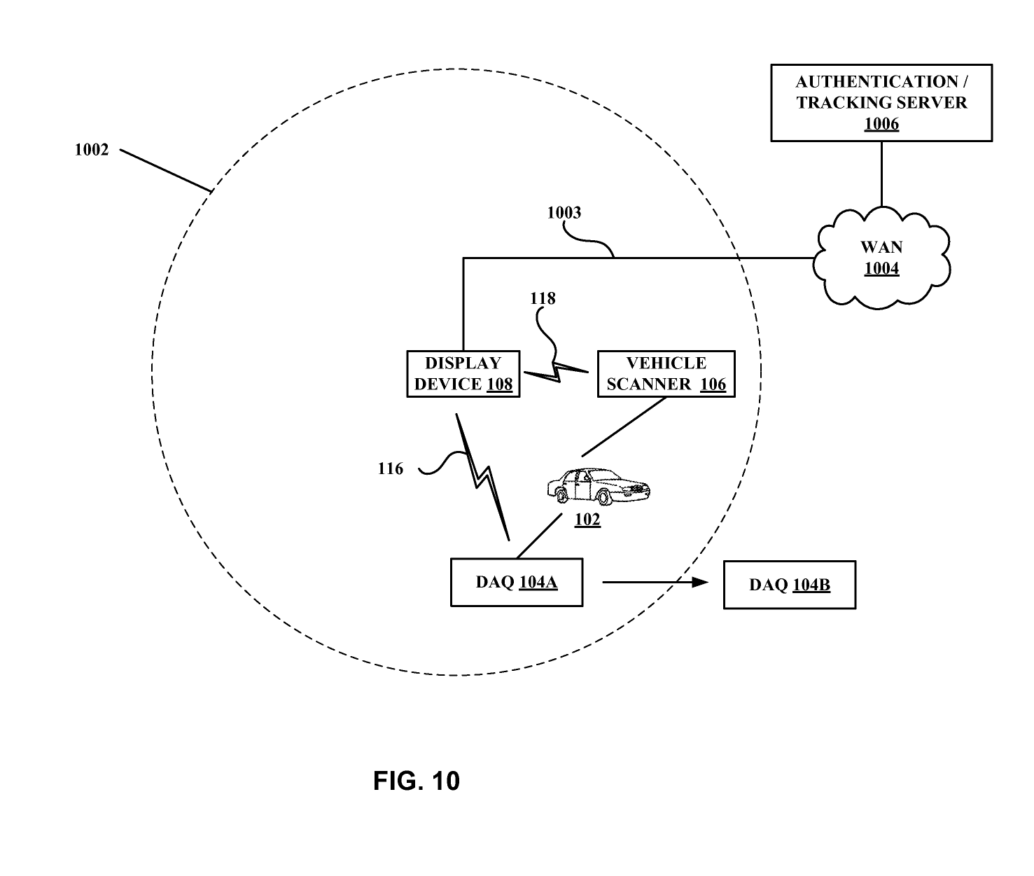

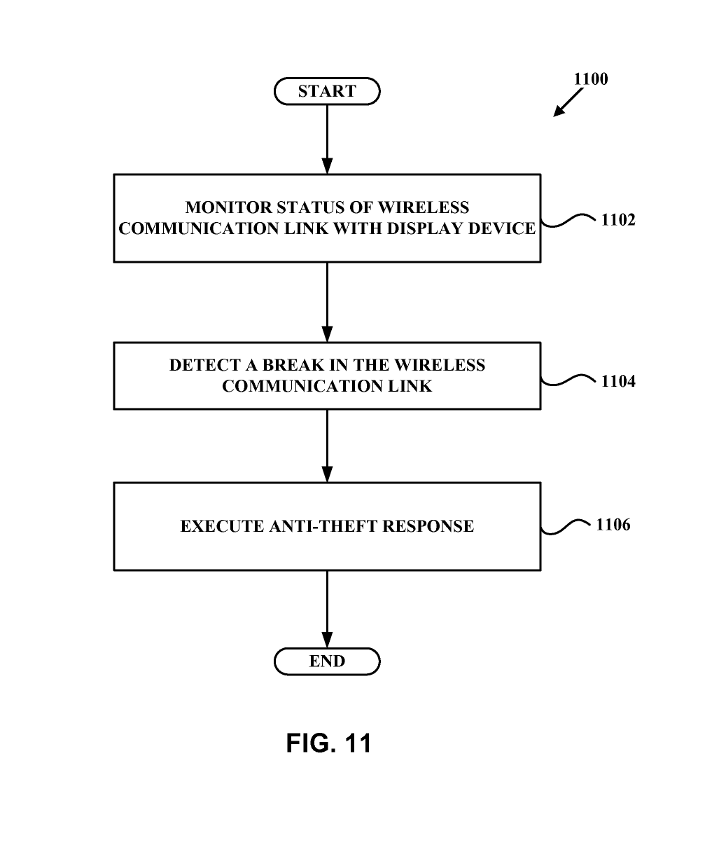

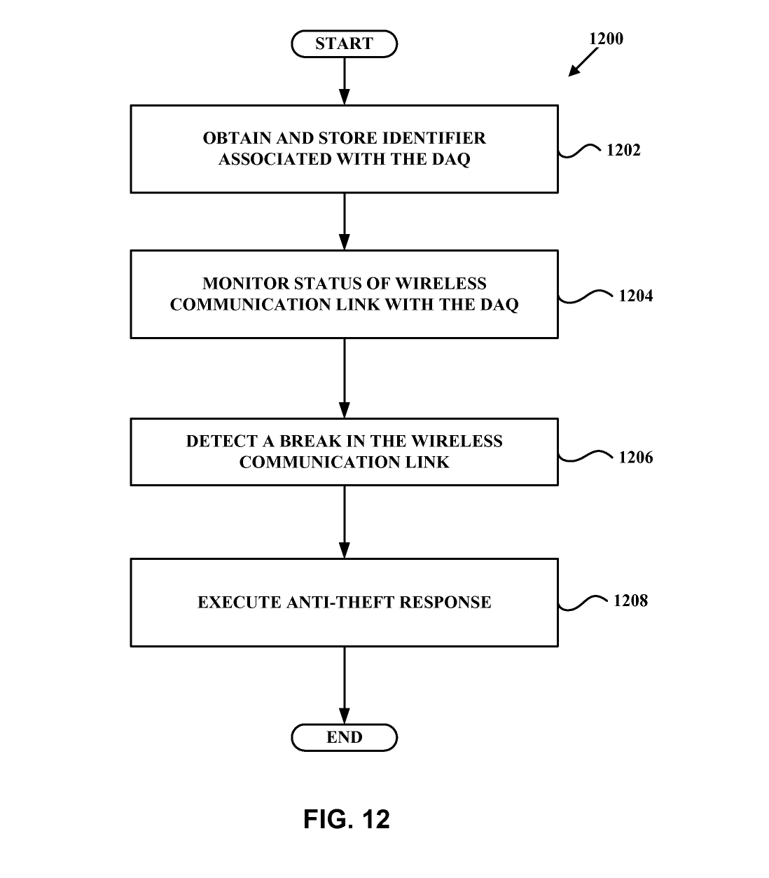

FIG. 10 illustrates a movement of a DAQ 104 from within communication range of a display device 108 to outside of the range of the display device 108. FIGS. 11 and 12 illustrate process flows that a respective DAQ 104 and display device 108 may execute in accordance with movement of DAQ 104 from position 104A within communication range of display device 108 to position 104B outside of communication range of display device 108. Although the embodiment in FIG. 10 uses the DAQ 104 to illustrate anti-theft features of a display device and a diagnostic device, the disclosed methods and apparatus are equally applicable to other diagnostic devices, such as vehicle scanner 106.

As shown in FIG. 10, display device 108 has a wireless communication range indicated by circumference 1002. Although transmission ranges are shown in the shape of a circle in FIG. 10 for ease of illustration, actual transmission range zones will vary in view of obstacles such as walls and in view of other nearby interfering RF devices. Display device 108 is illustrated connected to authentication and tracking server 1006 via WAN 1004 and connection 1003. Connection 1003 may be a wireless link that connects WAN 1004 with wireless transceiver 202, or may be a wired link that connects WAN 1004 with wired interface 206.

DAQ 104 and vehicle scanner 106 are illustrated in FIG. 10 as initially coupled to the vehicle 102 under test. For example, DAQ 104 may be connected to vehicle 102 via a lead that is also connected to one of ports 922-926 of DAQ 104 to measure, for example, a voltage. Vehicle scanner 106 may be connected to vehicle 102 via a vehicle interface cable coupled between port 600 and a corresponding port on vehicle 102. DAQ 104 is illustrated as wirelessly connected to display device 108 via wireless link 118 while in position 104A. Vehicle scanner 106 is illustrated as wirelessly connected to display device 108 via wireless link 116.

The authentication and tracking server 1006 may function as a centralized database of authorized devices and, upon request, may provide a status associated with a diagnostic device in response to a received status request. The status provided may be, for example, “clear” for a device that has not been reported as potentially stolen, and “potentially stolen” for a device that has been reported to the server 1006 as potentially stolen. Other alternative or additional status indicators could also be used. Authentication and tracking server 1006 may include a database or list stored in a computer readable memory that associates a status with each corresponding device being tracked.

In the context of this document, a computer-readable medium is an electronic, magnetic, optical, or other physical device or means that can contain or store a computer program or computer data for use by, or in connection with, a computer related system or method. The methods can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In some embodiments, methods executed at server 1006 may be implemented in hardware, comprising any one of, or combination of, the following technologies: (a) discrete logic circuit(s) having logic gates for implementing logic functions upon data signals, (b) an application-specific integrated circuit (ASIC) having appropriate combinational logic gates, (c) programmable gate array(s) (PGA), a field programmable gate array (FPGA), etc, or (d) other technologies now known or later developed.

Alternatively, server 1006 may include a general purpose processor that is transformed into a special purpose processor by executed software instructions read from the computer readable medium. It should be noted that the method can be stored on any computer-readable medium for use by, or in connection with, any computer-related system or method of server 1006.

Any process descriptions, steps, or blocks in flow diagrams should be understood as potentially representing modules, segments, or portions of code which include one or more executable instructions for implementing specific logical functions or steps in the process, and alternate implementations are included within the scope of the preferred embodiments of the methods in which functions may be executed out of order from that shown or discussed, including substantially concurrently or in reverse order, depending on the functionality involved, as would be understood by those reasonably skilled in the art.

As set forth above, the disclosed anti-theft methods and devices are directed to preventing theft of portable diagnostic devices by detecting and to deterring the removal of diagnostic devices from their operating area, and by tracking and reporting stolen diagnostic devices in order to prevent their further use.

Returning to FIG. 10, which illustrates the example embodiment where DAQ 104 is moved from position 104A existing within communication range of display device 108 to position 104B outside of communication range of display device 108, it is assumed for the purposes of this example that DAQ 104 in position 104A is already wirelessly connected to display device 108. FIG. 11 describes a process flow 1100 executed by DAQ 104 as it is moved from position 104A in FIG. 10 to position 104B. FIG. 12 describes a process flow 1200 executed by display device 108 as the DAQ 104 follows that the same path.

As set forth in FIG. 11, process flow 1100 comprises steps 1102, 1104, and 1106. At step 1102, the DAQ 104 monitors the status of its wireless communication link 116 with display device 108, at step 1104, DAQ 104 detects a break in the wireless communication link 116. At step 1106, DAQ 104 executes an anti-theft response. These steps will now be described in more detail below.

At step 1102 of process flow 1100, DAQ 104 monitors the status of its wireless communication link 116 while at position 104A. For example, wireless transceiver 802 may operate to monitor periodic indications from display device 108 to confirm the status of the wireless communication link 116. This indication may be, for example, transmitted data packets or perhaps transmitted acknowledgement packets acknowledging receipt of prior communications transmitted by wireless transceiver 802. Alternatively, this indication may be a pulse broadcast (or “heartbeat”) that may comprise intermittent, periodic, or semi-periodic broadcasts of signals from display device 108. Other methods of monitoring a status of a wireless link could also be used.

At step 1104, DAQ 104 moves from position 104A to 104B, and as a result of being moved outside of the communication range 1002 of display device 108, detects a break in the wireless communication link 116. The break could be detected by, for example, failing to receive a data packet from display device 108 for a particular period of time, or failing to receive an acknowledgment packet to one or more transmitted packets transmitted to display device 108. Additionally or alternatively, the break could be detected by the DAQ 104 failing to detect the pulse broadcast (heartbeat) transmitted by display device 108. Other methods of detecting a break in a wireless link could also be used.

Detecting a break in wireless link 116 may be an indication that DAQ 104 has either been stolen, or is in the process of being stolen. For example, if a DAQ 104 is removed from the garage at which display device 108 is located, it may have been removed without the authorization of the owner. As a result, at step 1106, and responsive to detecting the break in the wireless communication link 116, DAQ 104 executes an anti-theft response.

The anti-theft response taken by DAQ 104 may comprise one or more different responses. For example, DAQ 104 may sound an audible alarm that may be used to deter further movement of the DAQ 104 away from display device 108. The audible alarm may increase in volume as the duration of time without detecting display device 108 increases. The audible alarm may comprise, for example, a high-pitched tone or a spoken voice informing nearby users that an anti-theft response has been executed and requesting return to within a communication range of display device 108. Additionally or alternatively, a visual alarm may accompany the audible alarm, or may be provided instead of the audible alarm. The visual alarm may comprise, for example, flashing lights and or text displayed on display 900 of DAQ 104, indicating a potential theft and/or requested return to within a communication range of display device 108.

Additionally or alternatively, the anti-theft response executed by DAQ 104 may include locking the DAQ 104 and preventing further use of the DAQ 104. For example, DAQ 104 may stop responding to user changes to mode selectors 902, 904, 906, 908, 910, 912, 914, 916, and 918, and may stop reading signals from ports 922-926. DAQ 104 may remain locked until it is returned to within range of display device 108, or perhaps until it is provided with an unlock code. In one embodiment, the unlock code may be provided to DAQ 104 via a predetermined combination of mode selectors 902, 904, 906, 908, 910, 912, 914, 916, and 918. For example, a user may be required to call the manufacturer or some other third party and prove ownership of the device before the unlock code is provided to them. Additionally or alternatively, the unlock code could be provided to DAQ 104 via its wireless transceiver 802 or some other communications port. For example, a party associated with the manufacturer may cause a server such as server 1006 to transmit a specially formatted unlock packet via WAN 1004 and some other local wireless network with which DAQ 104 is connected, perhaps after a user proves ownership of the DAQ 104 and requests that the unlock code be sent. The unlock packet may be a packet transmitted in accordance with the TCP/IP protocol, and may contain a header portion and a data portion, the data portion including an embedded code that, upon receipt, causes the DAQ 104 to unlock. Other methods of locking and unlocking DAQ 104 could also be used.

In one embodiment, the anti-theft response may be executed by DAQ 104 only after a predetermined period of time after detecting the break in wireless communications link 116. For example, after moving from position 104A to 104B, DAQ 104 may delay executing an anti-theft response for a predetermined period of time, for example, between 0 and 600 seconds. After detecting the break in the wireless communications link 116 but prior to expiration of the predetermined period of time, the DAQ 104 may also provide a visual and/or audible indication of the break. The indication may provide a user with the opportunity to remedy the break in wireless connectivity by, for example, bringing the DAQ 104 back within the range 1002 of display device 108, prior to the DAQ 104 executing the anti-theft response.

FIG. 12 describes a process flow 1200 executed by display device 108 as the DAQ 104 follows the same path from position 104A to position 104B. As set forth in FIG. 12, process flow 1200 comprises steps 1202, 1204, 1206, and 1208. At step 1202, the display device 108 obtains and stores an identifier associated with the DAQ 104. At step 1204, the display device 108 monitors a status of the wireless communication link 116 with the DAQ 104. At step 1206, display device 108 detects a break in the wireless communication link 116. At step 1208, display device 108 executes an anti-theft response. These steps will now be described in more detail below.

At step 1202 of process flow 1200, DAQ 104 wirelessly connects with display device 108. If DAQ 104 has never connected with display device 108 before, this process may involve a pairing process. During or after the display device 108 and DAQ 104 wirelessly connect, display device 108 may obtain and store an identifier associated with DAQ 104. The identifier may be, for example, a MAC address, a hardware ID, a security key, a username, or some other identifier associated with DAQ 104 or a user of the DAQ 104.

At step 1204, display device 108 monitors the wireless communications link 116 established with DAQ 104. For example, wireless transceiver 202 may operate to monitor periodic indications from DAQ 104 to confirm the status of the wireless communication link 116. This indication may be, for example, transmitted data packets from the DAQ 104 or acknowledgement packets acknowledging receipt of prior communications transmitted by display device 108. Alternatively, this indication may be a pulse broadcast (or “heartbeat”) that may comprise intermittent, periodic, or semi-periodic broadcasts of signals from DAQ 104. Other methods of monitoring a status of a wireless link could also be used.

At step 1206, DAQ 104 moves from position 104A to 104B, and as a result of being moved outside of the communication range 1002 of display device 108, display device 108 detects a break in the wireless communication link 116. The break could be detected by, for example, failing to receive an acknowledgment packet to one or more transmitted packets transmitted to DAQ 104. Additionally or alternatively, the break could be detected by the display device 108 failing to detect the pulse broadcast (heartbeat) transmitted by DAQ 104. Other methods of detecting a break in a wireless link could also be used.

Detecting a break in wireless link 116 may be an indication that DAQ 104 has either been stolen, or is in the process of being stolen. For example, if a DAQ 104 is removed from the garage at which display device 108 is located, it may have been removed without the authorization of the owner. As a result, at step 1208, and responsive to detecting the break in the wireless communication link 116, display device 108 may execute an anti-theft response.

The anti-theft response taken by display device 108 may comprise one or more different responses. In one embodiment, the anti-theft response may include the display device 108 transmitting the identifier associated with the DAQ 104 to the remote authentication and tracking server 1006 via the WAN 1004 and network connection 1003. The transmission may instruct the server 1006 to identify any device(s) associated with the identifier as potentially stolen. The server 1006 may store that association and, in response to any future requests for the status of any device(s) associated with the identifier, report the device(s) as potentially stolen. A lookup of a stolen device identifier in the future may result in that report being transmitted back to the requester, to the authorities, to the manufacturer of the device(s), or to some other entity. The report may also include the location of the device(s) if that is provided to the server 1006 in the request or in some subsequent transmission.

Additionally or alternatively, the anti-theft response may include sounding an audible alarm at the display device 108. For example, display device 108 may sound an audible alarm that may be used to deter further movement of the DAQ 104 away from display device 108 and/or to alert those in the area about the potential theft attempt. The audible alarm may increase in volume as the duration of time without detecting the DAQ's 104 return within communication range 1002 of display device 108 increases. The audible alarm may comprise, for example, a high-pitched tone or a spoken voice informing nearby users that an anti-theft response has been executed and requesting return of the DAQ 104 to within a communication range of display device 108. Additionally or alternatively, a visual alarm may accompany the audible alarm, or may be provided instead of the audible alarm. The visual alarm may comprise, for example, flashing lights and or text displayed on display 300 of display device 108, indicating a potential theft and/or requested return to of the DAQ 104 to within a communication range of display device 108. Other anti-theft responses could also be implemented.

In one embodiment, the anti-theft response may be executed by display device 108 only after a lapse of a predetermined period of time after detecting the break in the wireless communications link 116. For example, after the DAQ 104 moves from position 104A to 104B, display device 108 may delay executing an anti-theft response for a predetermined period of time, for example, between 0 and 600 seconds. After detecting the break in the wireless communications link 116, but prior to expiration of the predetermined period of time, the display device 108 may also provide a visual and/or audible indication of the break. The indication may provide a user with the opportunity to remedy the break in wireless connectivity by, for example, bringing the DAQ 104 back to within the range 1002 of display device 108 prior to the display device 108 executing the anti-theft response.

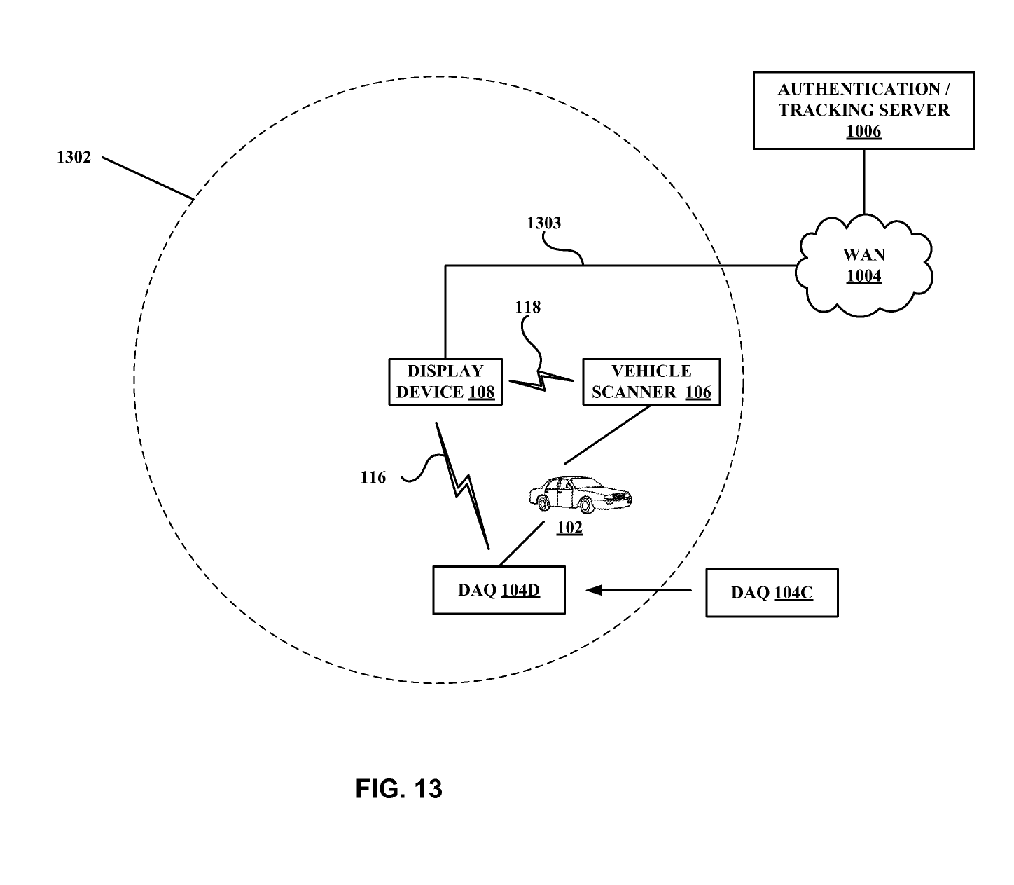

While a diagnostic device such as DAQ 104 exiting coverage area 1002 may trigger a response in DAQ 104 and/or display device 108, a diagnostic device such as DAQ 104 newly entering a coverage area 1302 of display device 108 may similarly trigger a response by DAQ 104 and/or display device 108. For example, FIG. 13 illustrates a scenario where a DAQ 104 (assumed to be entirely separate and distinct from the DAQ 104 of FIG. 10) moves from a position 104C somewhere outside of coverage area 1302 of display device 108 (assumed to be entirely separate and distinct from the display device 108 of FIG. 10) to a position 104D within coverage area 1302 of display device 108. While in FIG. 10 the focus was on detecting a potential theft of a diagnostic device as it happens, the focus in FIG. 13 is on newly detecting a presence of a potentially stolen diagnostic device entering coverage area 1302.

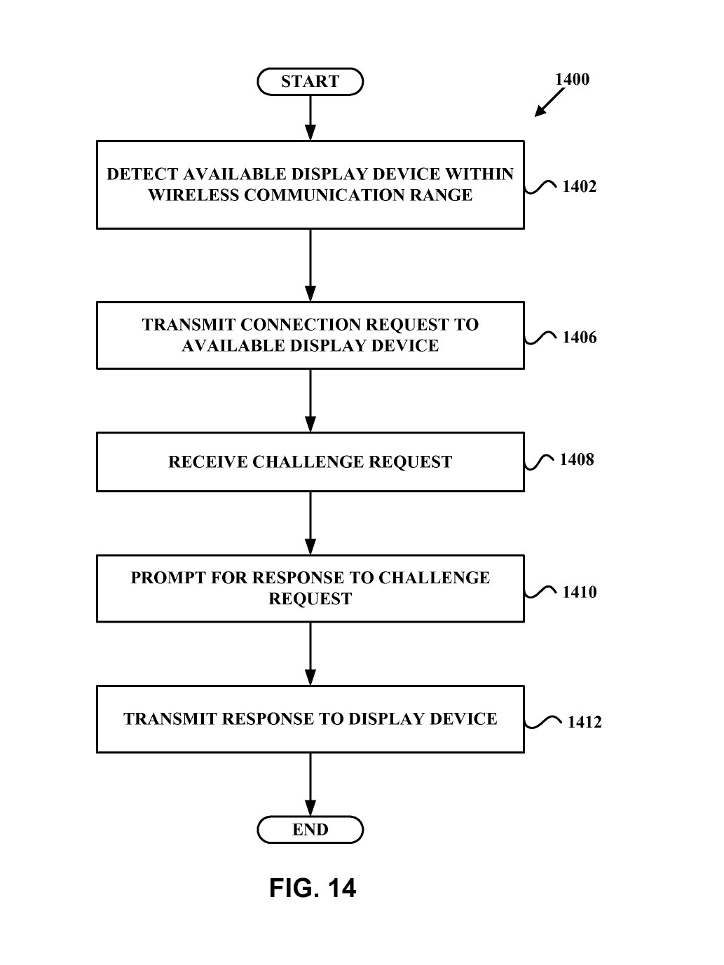

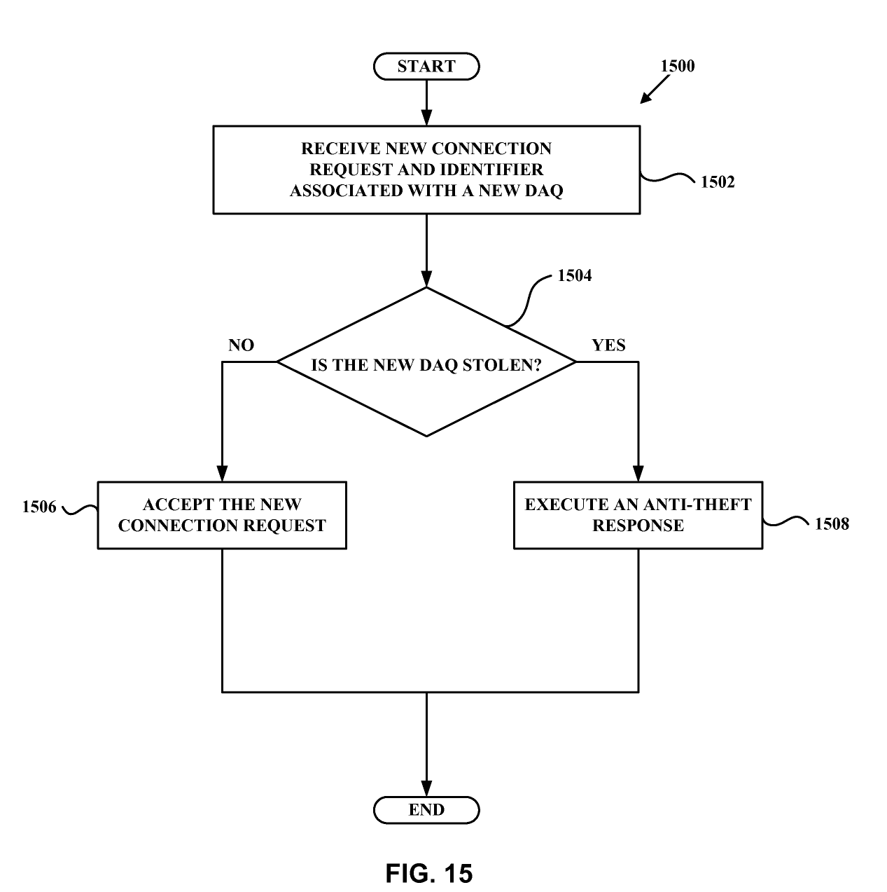

FIG. 14 describes a process flow 1400 executed by DAQ 104 as it is moved from position 104C to position 104D. FIG. 15 describes a process flow 1500 executed by display device 108 as the DAQ 104 follows the same path.

As set forth in FIG. 14, process flow 1400 comprises steps 1402, 1406, 1408, 1410, and 1412. At step 1402, the DAQ 104 detects an available display device 108 within wireless communication range 1302. At step 1406, DAQ 104 transmits a connection request to display device 108. At step 1408, DAQ 104 receives a challenge request. At step 1410, DAQ 104 prompts a user for a response to the challenge request. At step 1412, DAQ 104 transmits an entered response to the display device 108. These steps will now be described in more detail below.

At step 1402 of process flow 1400, DAQ 104 moves from position 104C to 104D within range 1302 of display device 108 and detects the availability of a wireless communications link 116 with display device 108. Responsive to detecting the availability, at step 1406, DAQ 104 transmits a connection request to display device 108. The request may include an identifier associated with DAQ 104. In response to receiving the connection request, display device 108 may compare the identifier associated with DAQ 104 to a whitelist of locally stored diagnostic device identifiers and, absent finding a match, transmit a challenge request to DAQ 104. The whitelist may be set by a manufacturer at a time of manufacture, or perhaps by a vendor upon sale or installation of the devices. In some cases, it may be generated and/or be editable by the owner.

Alternatively, display device 108 may be configured to automatically transmit a challenge request to DAQ 104 upon receipt of the connection request, without conducting any device identifier lookup. In another embodiment, display device 108 may be configured to transmit the received identifier to authentication and tracking server 1006 to determine the status of DAQ 104 as clean or potentially stolen diagnostic device. If the status comes back clean, perhaps no challenge request is transmitted to DAQ 104 by display device 108. If the status comes back as potentially stolen, the display device may only then transmit a challenge request to DAQ 104. In one embodiment, if the status comes back as potentially stolen, display device 108 may refrain from sending any challenge request to DAQ 104 (e.g., skipping steps 1408-1412 of FIG. 14), but may instead simply transmit an instruction to DAQ 104 indicating that it is potentially stolen and/or instructing it to cease functioning and lockup.

Returning to FIG. 14, at step 1408, DAQ 104 receives the challenge request. The challenge request asks DAQ 104 to validate itself by entering a password and transmitting the password to display device. As set forth above, a particular combination or activation of mode selectors 902, 904, 906, 908, 910, 912, 914, 916, and 918 may form all or part of the password. For example, the password may comprise moving rotary dial 902 all the way to the right, and depressing mode selector buttons 908, 912, and 918 in that order. The correct password may be stored at DAQ 104 or may be stored at display device 108. Alternatively, the correct password may be retrieved by DAQ 104 and/or display device 108 from some external server, such as authentication and tracking server 1006. In the latter case, the correct password may be changed at random or periodic intervals by a third party and a user may need to contact that third party to obtain the current password to use DAQ 104 with display device 108. Alternatively or additionally, the password may be initially set by a manufacturer, vendor, or user the first time the DAQ 104 is powered on and/or the first time DAQ 104 detects an available connection to the authentication and tracking server 1006 (perhaps via display device 108).

In the event that the correct password is stored locally at DAQ 104, step 1412 may be skipped. In this case, and responsive to the correct password being entered at DAQ 104, the DAQ 104 may allow a connection with display device 108 to be completed and further functionality unlocked.

Alternatively, and in the example of FIG. 14, the correct password may be stored at display device 108 (either previously stored or perhaps stored after being retrieved from the authentication and tracking server 1006 by display device 108). At step 1412, DAQ 104 transmits the entered password to display device 108. Display device 108 then compares the entered and transmitted password to the password stored at the display device 108. If display device 108 finds a match, it may complete the wireless connection with DAQ 104 and begin interfacing with DAQ 104 and/or displaying data from DAQ 104. If a match is not found, display device 108 may transmit an instruction to DAQ 104 to prompt a user to re-enter the password and transmit again.

After a predetermined number of incorrect attempts, display device 108 may transmit, and DAQ 104 may receive, an instruction to lockup and prevent further functioning of the device. In response to receiving such an instruction, DAQ 104 may lockup and prevent further use of the device. DAQ 104 may prevent further use for a second predetermined amount of time and then unlock, or may stay locked until an unlock code is provided, in a similar manner to that set forth above. In addition, display device 108 may take the additional step of transmitting the identifier associated with DAQ 104 to the authentication and tracking server 1006 via WAN 1004 and network connection 1303, and may instruct the server 1006 to mark the identifier associated with DAQ 104 as potentially stolen. As a result, use of DAQ 104 in any other network would still require an unlock procedure to make further use of DAQ 104 features. Further, even if DAQ 104 somehow becomes unlocked, any future coupling of DAQ 104 to authentication and tracking server 1006 will cause it to become locked up again.

FIG. 15 describes a process flow 1500 executed by display device 108 as the DAQ 104 follows the same path from position 104C to position 104D. Although for the purposes of this example the display device 108 is described, any other diagnostic device capable of wirelessly communicating with DAQ 104 could be used.

As set forth in FIG. 15, process flow 1500 comprises steps 1502, 1504, 1506, and 1508. At step 1502, the display device 108 receives a new connection request an identifier associated with a new (i.e., not seen before) DAQ 104. At step 1504, display device 108 determines whether the new DAQ 104 is potentially stolen. At step 1506, and after determining that the new DAQ 104 is not potentially stolen, display device 108 accepts the new connection request and provides display device 108 functionality to DAQ 104. At step 1508, and after determining that the new DAQ 104 is potentially stolen, display device 108 executes an anti-theft response. These steps will now be described in more detail below.

At step 1502 of process flow 1500, DAQ 104 moves to within wireless transmission range 1302 of display device 108 and transmits a new connection request to display device 108. At the same time, or via a subsequent transmission, DAQ 104 also transmits an associated identifier that can be used by display device 108 to identify DAQ 104. After receiving the connection request and associated identifier at step 1502, display device may then, at step 1504, determine whether the DAQ 104 is potentially stolen.

The display device 108 may determine whether or not the DAQ 104 is potentially stolen in one or more ways. In one embodiment, display device 108 may transmit the identifier associated with the DAQ 104 to the remote authentication and tracking server 1006 via WAN 1004 and network connection 1303. In response to the transmission, the display device 108 may subsequently receive a response from the server 1006 indicating whether or not the DAQ 104 is potentially stolen or clear.

Alternatively, the display device 108 may determine whether or not the DAQ 104 is stolen by accessing a locally stored whitelist and comparing the indicator provided by the DAQ 104 with one or more whitelisted indicators stored in the whitelist. Responsive to finding a match, the display device 108 may determine that the DAQ 104 is clear. If no match is found, the display device may determine that the new vehicle diagnostic device is potentially stolen. In the latter case, display device 108 may take the additional step of reporting the status of DAQ 104 to server 1006. As set forth above, the whitelist may be set by a manufacturer at a time of manufacture, or perhaps by a vendor upon sale or installation of the devices. In some cases, it may be generated and/or be editable by the owner.

Alternatively, the display device 108 may determine whether or not the DAQ 104 is stolen by transmitting a challenge request to the DAQ 104. In response to receiving such a challenge request, DAQ 104 may prompt a user to enter a password via one or more of the mode selectors 902, 904, 906, 908, 910, 912, 914, 916, and 918. After entering the password at the DAQ 104, the DAQ 104 may transmit the entered password to display device 108. The display device 108 may then compare the received password to a stored password. If a match is found, the display device 108 may determine that the DAQ 104 is clear. If no match is found, the display device 108 may determine that the DAQ 104 is potentially stolen. In the latter case, display device 108 may take the additional step of reporting the status of DAQ 104 to server 1006. The password may be initially set by a manufacturer, vendor, or user the first time the DAQ 104 is powered on and/or the first time DAQ 104 detects an available connection to the display device or to the authentication and tracking server 1006 (perhaps via display device 108).

Regardless of the particular method of determining whether the DAQ 104 is potentially stolen, if display device 108 determines in step 1504 that DAQ 104 is clear, process flow 1500 proceeds to step 1506, in which display device 108 accepts the new connection request from DAQ 104, and display device 108 can begin sending commands to DAQ 104 and DAQ 104 can begin sending data to display device 108 via wireless link 116.

On the other hand, if display device 108 determines in step 1504 that DAQ 104 is potentially stolen, process flow 1500 proceeds to step 1508, at which display device 108 executes an anti-theft response. The anti-theft response taken by the display device 108 may comprise one or more different responses.

For example, the anti-theft response may include the display device 108 providing an indication of the DAQ's 104 potentially stolen status via a visual or audio indicator. The audio indicator may be an audible alarm that may be used to deter further use of the potentially stolen DAQ 104. The audible alarm may comprise, for example, a high-pitched tone or a spoken voice informing nearby users that a potentially stolen DAQ 104 has moved to within a communication range 1302 of display device 108. Additionally, a visual alarm may accompany the audible alarm, or may be provided instead of the audible alarm. The visual alarm may comprise, for example, flashing lights and/or text displayed on display 300 of display device 108, indicating that a potentially stolen DAQ 104 has entered to within a communication range 1302 of display device 108.

In another embodiment, the anti-theft response may include the display device 108 accepting the connection request, and then transmitting an instruction to the DAQ 104 via the wireless communications link 116 to lock up and cease further functioning. DAQ 104 may remain locked until it is provided with an unlock code. The unlock code may be provided to DAQ 104 via a predetermined combination of mode selectors 902, 904, 906, 908, 910, 912, 914, 916, and 918. For example, a user may be required to call the manufacturer or some other third party and prove ownership of the device before the unlock code is provided. Additionally or alternatively, the unlock code could be provided to DAQ 104 via its wireless transceiver 802 or some other communications port. For example, a party associated with the manufacture may cause a server such as server 1006 to transmit a specially formatted unlock packet via WAN 1004 and display device 108, perhaps after a user proves ownership of the DAQ 104 and requests that the unlock code be sent. The unlock packet may be a packet transmitted in accordance with the TCP/IP protocol, and may contain a header portion and a data portion, the data portion including an embedded code that, upon receipt, causes the DAQ 104 to unlock. In those diagnostic device comprising a memory card slot (such as vehicle scanner 106, or a modified version of the DAQ 104), the unlock code could be provided by the insertion of a specially formatted memory card. Other methods of locking and unlocking DAQ 104 could also be used.

In a further embodiment, the anti-theft response could include the display device 108 transmitting the identifier associated with the DAQ 104, along with a location of the DAQ 104, to the remote authentication and tracking server 1006. The transmission may instruct the server 1006 to identify any device(s) associated with the transmitted identifier as potentially stolen. The server 1006 may store that association and, in response to any future requests for the status of any device(s) associated with the identifier, report the device(s) as potentially stolen. The report may be transmitted back to the requester, to the authorities, to the manufacturer of the device(s), or some other entity. The report may also include the location of the device(s) if provided to the server 1006 in the request or in some subsequent transmission. While most of the above-noted methods and devices are directed to a first diagnostic device detecting, reporting, and/or reacting to a potential theft of a second diagnostic device such as DAQ 104 or vehicle scanner 106, anti-theft methods may be also executed by the first diagnostic device on itself. While the forthcoming description describes the display device 108 as a preferred embodiment, the same functions could be executed at any diagnostic device including, for example, DAQ 104 and vehicle scanner 106.

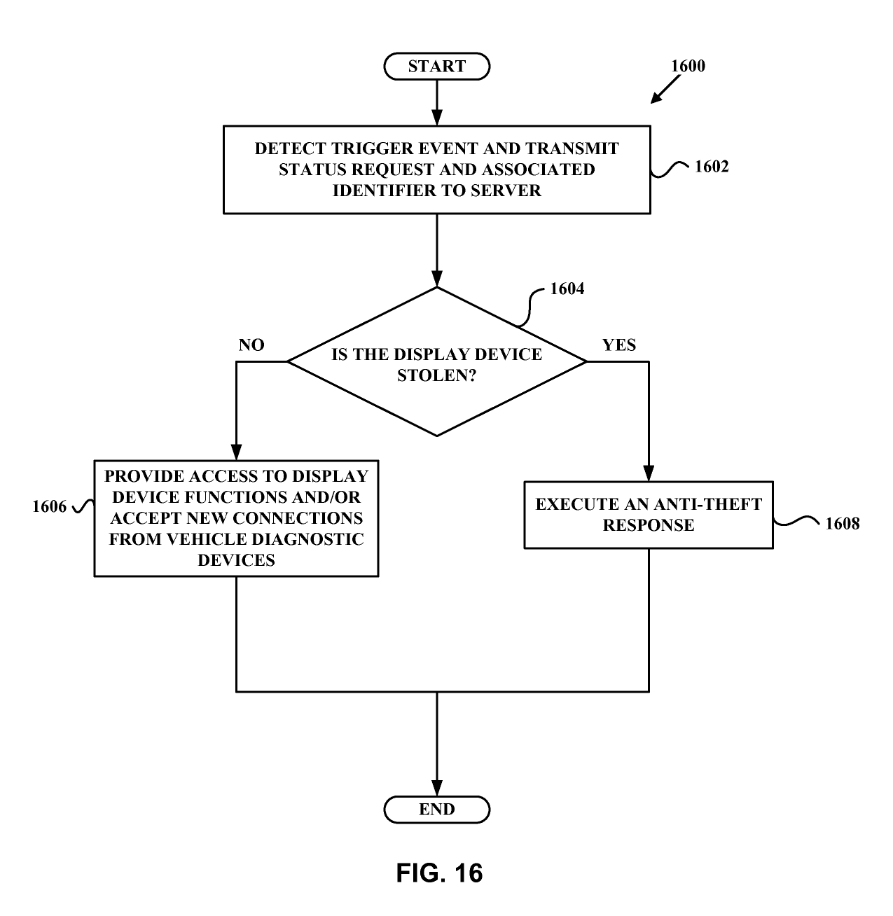

Process flow 1600 in FIG. 16 sets forth one embodiment of a method that display device 108 may execute to prevent, detect, and/or respond to a suspected theft of the display device 108. As set forth in FIG. 16, process flow 1600 comprises steps 1602, 1604, 1606, and 1608. At step 1602, the display device 108 detects a trigger event. At step 1604, the display device 108 determines whether the display device 108 is potentially stolen. At step 1606, and responsive to the display device 108 determining that it is not potentially stolen, display device 108 provides a user and other nearby diagnostic devices access to its functions and/or begins accepting connections from other nearby diagnostic devices. At step 1608, and responsive to the display device 108 determining that it is potentially stolen, display device 108 executes an anti-theft response. These steps will now be described in more detail below.

At step 1602, display device 108 detects a trigger event. The trigger event may include the display device 108 initially receiving operating power (i.e., being plugged in or having a “power-on” button pressed), the display device 108 detecting an available connection with the remote authentication and tracking server 1006, an expiration of a predetermined period of time, and/or some other event. For example, upon initially receiving operating power or powering on, the display device 108 may startup in a “locked” mode, and only unlock after automatically contacting server 1006 and verifying its clear status (i.e., not potentially stolen). The display device 108 may, alternatively, provide functionality upon power up, but begin attempting to contact the remote authentication and tracking server 1006 and, upon first successful contact, verify its clear status. Additionally, the display device 108 may, at predetermined intervals, conduct another check with the remote authentication and tracking server 1006.

The display device 108 may be further configured to lockup and/or stop further functioning if a predetermined number of subsequent checks fail to reach the server 1006. For example, the display device 108 may lockup after five failed attempts to reach server 1006. Prior to locking up, display device 108 may provide an indication that connectivity must be provided to the remote authentication and tracking server 1006 within a pre-determined amount of time, after which pre-determined amount of time, the display device 108 will cease to function. The indication may be an audible or visible indication. If the display device 108 is not provided with the requested connectivity within the pre-determined amount of time, the display device 108 may only then lockup and prevent the display device 108 from functioning.

For the purposes of the example in FIG. 16, it is assumed that display device 108 has a valid, operable connection to server 1006. In response to detecting the trigger event, display device 108 transmits a status request and an identifier associated with the display device 108 to server 1006. The status request and identifier may be sent in a same request or in separate requests. The identifier may be, for example, a MAC address, a security key, a hardware ID, a username, or some other identifier associated with display device 108.

In response to receiving the request, the remote authentication and tracking server 1006 may respond with a status of the display device 108, including for example, clear (no reported thefts) or potentially stolen (a reported theft). In response to receiving a clear indication, the display device 108 determines that it is not stolen and processing proceeds to step 1606, where display device 108 provides access to display device 108 functions and/or accepts new connections from diagnostic devices such as DAQ 104 and/or vehicle scanner 106.

If, on the other hand, server 1006 reports that the identifier associated with display device 108 has been reported as potentially stolen, processing proceeds to step 1608, where display device 108 executes an anti-theft response. The anti-theft response taken by the display device 108 may comprise one or more different responses. For example, the response may comprise the display device 108 transmitting a location of the display device 108 to the remote authentication and tracking server 1006. The operator of the server 1006 may then use this information to contact the proper authorities and/or the registered owner of the display device 108. The location information may be provided by a GPS receiver, or may be generated by a triangulation operation executed by the display device 108 using detected WiFi and/or cellular signals. Other methods of determining location could also be used by the display device 108.

In another embodiment, the anti-theft response taken by the display device 108 may include the display device 108 locking up and ceasing further functioning. Display device 108 may remain locked until an unlock code is provided. The unlock code may be provided to display device 108 via a predetermined combination of user controls 306 including, among others, power button 308, brightness button 310, keyboard button 312, cursor left button 316, cursor right button 318, cursor up button 320, cursor down button 322, menu item selection button 324, and quick access button 326. For example, a user may be required to call the manufacturer or some other third party and prove ownership of the display device 108 before the unlock code is provided. Once the particular combination of user controls is communicated to the user and entered into the display device 108, and the display device 108 verifies that the entered unlock code is correct, the display device 108 may unlock. The correct matching unlock code may be set in the display device 108 by the manufacturer at the time of manufacture, by a vendor at the time of sale, or perhaps by a user at the time of sale or time of delivery. Alternatively, the correct matching unlock code may be communicated to display device 108 via WAN 1004 and one of display device's 108 wireless transceiver 202, wired interface 206, or some other communications port.

Additionally or alternatively, the unlock code itself could be provided to display device 108 via its wireless transceiver 202, its wired interface 206, or some other communications port. For example, a party associated with the manufacturer may cause a server such as server 1006 to transmit a specially formatted unlock packet to display device 108 via WAN 1004 and network connection 1303, perhaps after a user proves ownership of the display device 108 and requests that the unlock code be sent. The unlock packet may be a packet transmitted in accordance with the TCP/IP protocol, and may contain a header portion and a data portion, the data portion including an embedded code that, upon receipt, causes the display device 108 to unlock. In the event the display device 108 comprises a memory card slot, the unlock code could be provided by the insertion of a specially formatted memory card. Other methods of locking and unlocking display device 108 could also be used.

The display device 108 may additionally or alternatively provide an indication of its potentially stolen status via a visual or audio indicator. For example, display device 108 may sound an audible alarm that may be used to deter further use of the display device 108. The audible alarm may comprise, for example, a high-pitched tone or a spoken voice informing nearby users that an anti-theft response has been executed and that the display device 108 has been reported as potentially stolen. Additionally or alternatively, a visual alarm may accompany the audible alarm, or may be provided instead of the audible alarm. The visual alarm may comprise, for example, flashing lights and or text displayed on display 300 of display device 108, indicating a potential theft and/or requesting that a particular phone number or action be taken in response to the status. Other anti-theft responses could also be implemented.

### III. Conclusion

Example embodiments of the present invention have been described above. Those skilled in the art will understand that changes and modifications may be made to the described embodiments without departing from the true scope and spirit of the present invention, which is defined by the claims.

We claim:

1. A vehicle diagnostic device for diagnosing a vehicle under test, comprising:
a processor;
data storage;
a vehicle interface configured to interface with the vehicle under test and obtain diagnostic data from the vehicle; and
a wireless communications interface configured to wirelessly communicate with one or more other diagnostic devices;
wherein the processor is configured to:
monitor a status of the wireless communications interface; and
responsive to detecting a break in wireless connectivity with the one or more other diagnostic devices, execute an anti-theft response.

2. The vehicle diagnostic device of claim 1, wherein the anti-theft response comprises an audible alarm.

3. The vehicle diagnostic device of claim 1, wherein the audible alarm increases in volume over time the longer the break in wireless connectivity exists.

4. The vehicle diagnostic device of claim 1, wherein the anti-theft response comprises locking the vehicle diagnostic device and preventing further use of the device.

5. The vehicle diagnostic device of claim 1, wherein the anti-theft response continues until the processor detects that wireless connectivity with the one or more other diagnostic devices has been restored.

6. The vehicle diagnostic device of claim 1, wherein the processor is further configured to activate the anti-theft response only after a predetermined period of time after detecting the break in wireless connectivity.

7. The vehicle diagnostic device of claim 6, wherein the predetermined period of time is more than 0 seconds and less than 600 seconds.

8. The vehicle diagnostic device of claim 6, wherein the processor is further configured to, after detecting the break in wireless connectivity but prior to expiration of the predetermined period of time, cause the vehicle diagnostic provide a visual indication of the break in wireless connectivity.

9. The vehicle diagnostic device of claim 8, wherein the visual indication comprises a lighted indictor at an outer surface of the vehicle diagnostic device.

10. The vehicle diagnostic device of claim 1, wherein the vehicle diagnostic device is a vehicle scanner and the one or more other diagnostic devices are display devices.

11. The vehicle diagnostic device of claim 1, wherein the vehicle diagnostic device is data acquisition unit (DAQ).

12. A method of preventing theft of a first vehicle diagnostic device comprising:
the first diagnostic device retrieving diagnostic data from a vehicle under test and transmitting the diagnostic data to one or more second diagnostic devices via a wireless communications link;
the first diagnostic device monitoring a status of the wireless communications link with the one or more second diagnostic devices;
responsive to detecting a break in wireless connectivity with the one or more second diagnostic devices, the first diagnostic device executing an anti-theft response.

13. The method of claim vehicle diagnostic device of claim 12, wherein the anti-theft response comprises sounding an audible alarm.

14. The method of claim 12, wherein the anti-theft response comprises locking the first diagnostic device and preventing further use of the first diagnostic device.

15. The method of claim 12, wherein the anti-theft response continues until wireless connectivity with the one or more second diagnostic devices has been restored.

16. The method of claim 12, wherein the anti-theft response is executed only after a predetermined period of time after detecting the break in wireless connectivity.

17. The method of claim 16, wherein the predetermined period of time is more than 0 seconds and less than 600 seconds.

18. The method of claim 16, further comprising, after detecting the break in wireless connectivity but prior to expiration of the predetermined period of time, providing a visual indication of the break in wireless connectivity.

19. A vehicle diagnostic device for diagnosing a vehicle under test, comprising:
a processor;
data storage;
an input interface;
a vehicle interface configured to interface with the vehicle under test and obtain diagnostic data; and
a wireless communications interface configured to communicate with one or more second diagnostic devices;
wherein the processor is configured to:
detect that one or more available second diagnostic devices are within communication range of the vehicle diagnostic device;
transmit a connection request to one of the second diagnostic devices via the wireless communications interface;
responsive to the transmission, receive a challenge request from the one of the second diagnostic devices via the wireless communications interface and responsively prompt a user to enter a password via the input interface; and
transmit the entered password to the one of the second diagnostic devices via the wireless communications interface.

20. The vehicle diagnostic device of claim 19, wherein the input interface comprises input elements including one or more of buttons, switches, and rotary dials, and wherein the password transmitted to the one of the second diagnostic devices comprises a combination of two or more activations of the input elements.

21. The vehicle diagnostic device of claim 19, wherein the processor is further configured to, responsive to receiving an indication from the one of the second diagnostic devices that the transmitted password was incorrect, prompt the user to reenter the password.

22. The vehicle diagnostic device of claim 21, wherein the processor is further configured to, responsive to transmitting a predetermined number of incorrect passwords and receiving an instruction to lockup and prevent further functioning of the vehicle diagnostic device, lock up and prevent further functioning of the vehicle diagnostic device, for at least a second predetermined amount of time.

23. A method of preventing theft of a vehicle diagnostic device comprising:
the vehicle diagnostic device detecting that one or more second diagnostic devices are within wireless communication range of the vehicle diagnostic device;
the vehicle diagnostic device transmitting a connection request to at least one of the second diagnostic devices;
responsive to the transmission, the vehicle diagnostic device receiving a challenge request from the at least one second diagnostic device via a wireless communications interface and responsively prompting a user to enter a password via an input interface provided at the vehicle diagnostic device; and
the vehicle diagnostic device transmitting the entered password to the at least one second diagnostic device via the wireless communications interface.

24. The method of claim 23, wherein the input interface comprises input elements including one or more of buttons, switches, and rotary dials, and wherein the password transmitted to the at least one diagnostic device comprises a combination of two or more activations of the input elements.

25. The method of claim 23, further comprising, responsive to an incorrect password being entered and transmitted to the at least one second diagnostic device, receiving an indication of the failure and prompting the user to reenter the password.

26. The method of claim 25, further comprising, responsive to transmitting a predetermined number of incorrect passwords and receiving an instruction to lockup and prevent further functioning of the vehicle diagnostic device, locking up and preventing further functioning of the vehicle diagnostic device, for at least a second predetermined amount of time.
